(19) United States
(12) Patent Application Publication
(10) Pub. No.: US 2004/0054566 A1
(43) Pub. Date: Mar. 18, 2004

(54) Method and apparatus for event driven project management

(76) Inventor: Jack Ivan J'Maev, Chino, CA (US)

Correspondence Address: Jack J'Maev, SUITE 110, 11800 CENTRAL AVE., CHINO, CA, 91710, US

(21) Appl. No.: 10/462,495

(22) Filed: Jun. 16, 2003

Related U.S. Application Data
(60) Provisional application No. 60/389,681, filed on Jun. 17, 2002.

(51) Int. Cl. G06F 17/60

(52) U.S. Cl. 705/7

(57) ABSTRACT

Projects are managed by logging events. As events are logged, they are presented to a user in order to occurrence. Events trigger tasks or subprojects that are presented to the user interspersed with the event log. Each event log also provides for associated computer files. Computer files are automatically created from database records or are acquired as images.

### RELATED APPLICATIONS

This present application is related to a provisional application Ser. No. 60/389,681 filed on Jun. 17, 2003, entitled “Method and Apparatus for Event Driven Project Management”, by J'maev, currently pending, for which the priority date for this application is hereby claimed.

### BACKGROUND OF THE INVENTION

In a general sense, a project can be segregated into a plurality of tasks. Project management systems have traditionally been designed to manage a project by tracking the progress of the individual tasks that make up the project. During the planning stage of a project, the amount of work or effort required to accomplish each task may be estimated. During the planning process, the beginning and completion of each task can be determined by employing a leveling process that considers the amount of effort each task is estimated to require and the availability of key resources such as labor. Other factors may drive the scheduled beginning or completion of each task; some of these may include task precedence and material availability.

It is only natural that known project-planning systems allow a user to track project progress by means of task tracking. In a typical software project-planning system, each task is typically described in a task record comprising a project database. The project database may itself comprise several tables. A project-planning database may comprise an overall project description table. This table may comprise fields for the name of the project, the name of the project manager, the name of the client for whom the project is being performed and the like. The database will likely comprise a tasks table that is used to store the aforementioned task records. A task record may comprise fields for task name, start date, end date and an effort requirement. Other tables in the database may be used to record the quantity and type of resources each task will require.

The traditional project planning paradigm assumes that there is little or no variation between the estimated tasks and the order in which they must be accomplished and the actual execution of the project. Because of this, known project management systems rigidly enforce the precedence of tasks and the start and end of each task. This allows a planner to forecast the impact of each task on the overall success of the project. Some of these known systems employ a critical path method that identifies a sequential string of tasks that may contribute to the demise of the success of the project.

Known project management software systems have been adopted by almost all industries because they serve as excellent tools for tracking tasks. Traditional project planning is well suited to any situation where the structure of tasks is deterministic. For example, a construction project may be defined in accordance with a well-established task sequence model; tasks must be completed in a particular sequence (i.e. the concrete foundation footing must be poured and allowed to harden before the walls of a building can be erected). Product development is another field where the task can be structured according to specific requirements. In almost any endeavor, a project may be partitioned into a plurality of individual tasks and the execution of each task can be tracked relative to an established task precedence and the availability of resources.

These traditional notions of task-oriented project management may be well suited in some situations, as already illustrated, but they do not support a wide range of activities where the order of tasks may not be predicted. In many cases, even the need to perform a task may not be evident based on knowledge available during the planning stage. In any situation where the need to accomplish a particular task may arise as a result of a future event, task-oriented project planning is simply inappropriate to track the progress of activities related to the project.

Consider the legal profession. Projects can almost never be planed according to a pre-established series of tasks. The reason for this is simple, new tasks may need to be performed in response to the actions of an adverse party. In these situations, the adverse party is usually unwilling to conform their activity to a particular task-oriented plan. The legal profession, though, is only one example of an industry where tasks must be performed in response to events.

### SUMMARY OF THE INVENTION

The present invention comprises a method for managing projects through event recognition. According to one example method, once an event is recognized it is recorded. Also, once the event is recognized, a task that is associated with the event is spawned. According to one variation of the present method, a resource is assigned to task. According to yet another variation of the present method, the task is scheduled for execution. According to one additional variation of the present method, the task is scheduled by determining an automatic due period and then establishing a due date for the task based on the occurrence of the event and the automatic due period.

According to yet another illustrative variation of the present method, a computer file may need to be associated with the event. Accordingly, the type of computer file that needs to be associated with the event is determined and then the computer file is actually associated with the event. According to yet another alternative variation of the present method, a computer file is associated with the event by retrieving a template file, retrieving information from a database according to template file and then creating a file image according to the template and the information retrieved from the database. Then, the file image is stored in a database or the file image is stored in a computer file and a reference to computer file is stored in the database. In both of these instances, the record containing either the file image or a reference to a computer file can be discovered according to the event.

According to yet another example embodiment of the present method, a computer file is associated with an event of by acquiring a graphic image and then creating a file image based on the acquired graphic image. Then, the file image is stored in a database record or in a computer file. In the case where the file image is stored in a computer file, a reference to the computer file is stored in the database record. The database record is then discoverable according to the event.

According to yet another example method of the present invention, a macro that is associated with the event is executed once the event is recognized. According to yet another variation of the present method, a task is sponsored once an event is recognized by spawning a sub project that itself comprise as a plurality of tasks.

In order to present a structured full of the project to a user, managing the project according to one variation of the present method further comprises presenting a list of events together with a description of each event. A task description is further provided when a spawned task consists of one task. Otherwise, a sub project description is presented when the spawned task comprises a sub project (i.e. a plurality of tasks). According to one variation of the present method, present in a sub project description is accomplished by representing each task of sub project in a timeline format.

According to one variation of the present method, an indication is provided to user when a computer file is associated with the event. Accordingly, the computer file is presented to the user when the user requests presentation of said computer file.

The present invention also comprises a computer program for managing a project. According to one embodiment of the invention, the computer program comprises a project management executives that is capable of recognizing an event, logging the event and then spawning a task that is associated with the event. According to one alternative embodiment of the present invention, the project management executives further capable of assigning a resource to the task that it spawns. According to one additional illustrative embodiment of the present invention, the project management executives further capable of scheduling task. According to one alternative embodiment of the present invention, the project management executives schedules a task by determining an automatic due period for the task and then establishing a due date for the task based on the occurrence of the event and the automatic due period.

According to one example my butt of the present invention, the project management executives further capable of determining what type of file needs to be associated with an event. Once the project management executives determines the type of file that needs to be associated with the event, it associated computer file of that type with the event.

One alternative embodiment of the present invention, the project management executive associates a computer file by retrieving a template file, retrieving information from a database according to template file and then creating a file image according to the template and information retrieved from the database. Once the file image is created, is stored in the database record or in a computer file. In the case where the file image is stored in a computer file, a reference to the computer file is stored in the database record. It association to the event is made through this database record.

According to yet another alternative embodiment of the project management executive, a computer file is associated with an event by acquiring image and then creating a file image according to the graphic image. The file image is then stored either in a database record or in a computer file. Where the file image is stored in a computer file, a reference to the computer file is stored in the database record. Again, an association to the event is made through this database record.

According to one example embodiment of the project management executive, project management executive executes a macro that is associated with the event.

According to yet another example embodiment of the present invention, the computer program further comprises a project management user interface. The project management user interface is capable of listing a description of an event and a description of a task that a spawned when the event is recorded. Where a sub project is spawned in response to an event, the project management user interface describes the spawned sub project as a plurality of tasks. According to one example embodiment of the project management user interface, a task belonging to a sub project is presented to a user in a timeline format.

According to one illustrative embodiment of the present invention, the project management executives further capable of presenting a file access control to user when a computer file is associated with an event. The project management executives further is capable, according to one alternative embodiment of the present invention, of launching a helper application when the user actuates the file access control.

### BRIEF DESCRIPTION OF THE DRAWINGS

The foregoing aspects are better understood from the following detailed description of one embodiment of the invention with reference to the drawings, in which:

FIG. 1 is a flow diagram that depicts one illustrative method for managing projects by responding to events;

FIG. 2 is a pictorial representation of one illustrative structure for a table that may be used to store event definitions according to the teachings of the present invention;

FIG. 2A is a pictorial representation of a table that may be used according to the teachings of the present method to define executable macros that may be spawned in response to a particular event;

FIG. 3 is a pictorial illustration of one illustrative structure for a template defining a word processing document;

FIG. 4 is a pictorial representation of a one example structure of a table that may be used to define the types of events that may be spawned in response to a particular event;

FIG. 5 is a pictorial representation of one possible structure for a table that may be used to define the types of subprojects that may be spawned in response to a particular type of event;

FIG. 6 is a pictorial representation of one illustrative structure for a table that may be used to store definitions of subprojects according to the teachings of the present invention;

FIG. 7 is a pictorial representation of one possible embodiment of a table that may be used to store resource requirements for tasks defined according to the teachings of the present invention;

FIG. 8 is a pictorial representation of one illustrative structure of a table that may be used to define the types of events that may be spawned when a task comprising a subproject is initiated or completed;

FIG. 9 is a pictorial representation of one possible structure of a project table that may be used to define projects that may be managed by a project management system commensurate with the teachings of the present invention;

FIG. 10 is a pictorial representation of one example structure of an event table that may be used to record events as they occur and are thus recognized in accordance with the teachings of the present invention;

FIG. 11 is a pictorial representation of one illustrative structure of a table that may be used to record a hierarchy relationship between a newly recorded event and a spawned event associated with the newly recorded event;

FIG. 12 is a pictorial representation of one illustrative embodiment of a table that may be used to record tasks comprising subprojects that may be spawned according to the teachings of the present method;

FIG. 13 is a pictorial representation of one possible structure of a table that may be used according to the present method to record the spawning of an event by a task comprising a subproject;

FIG. 14 is a flow diagram that presents one possible series of steps for reporting task progress illustrative of the present invention;

FIG. 15 is a pictorial representation of one possible structure for a report that may be used to present task progress according to the teachings of the present method;

FIG. 16 is a pictorial representation of one possible structure of a software program that embodies the teachings of the present method;

FIG. 17 is a representation of one illustrative example of a project definition GUI that may be created by the GUI manager comprising the present invention;

FIG. 18 is a pictorial representation of one possible embodiment of a define event type GUI that may be used by a software program that implements the method of the present invention;

FIGS. 19 and 20 are pictorial representations of illustrative embodiments of a define spawned events GUI and a define spawned subprojects GUI that may be used by a user to specify what events/subprojects may be spawned in response to a particular event;

FIG. 21 is a pictorial representation of one illustrative embodiment of a define subproject GUI that may be used by a user to specify the structure of a subproject that may be spawned in response to an event according to the teachings of the present invention;

FIG. 22 is a pictorial representation of one example embodiment of a project tracking GUI that may be used to track projects according to the teachings of the present invention;

FIG. 23 is a pictorial representation of a new event selection GUI that may be used by a user to acknowledge a new event; and

FIG. 24 is a data flow diagram that depicts some illustrative interactions between a project management executive and helper applications according to the teachings of the present invention.

### DETAILED DESCRIPTION OF THE INVENTION

The present intention comprises a method for managing projects. The present invention also comprises a software program that embodies the teachings of the present method. Project management may be viewed as an event-driven process. Consider a situation where a particular task must be performed in response to a particular event. According to traditional project management paradigms, tasks for a particular project are typically scheduled in advance through a project planning activity. A task scheduled in advance in accordance with known project management paradigms cannot be executed in response to a particular event.

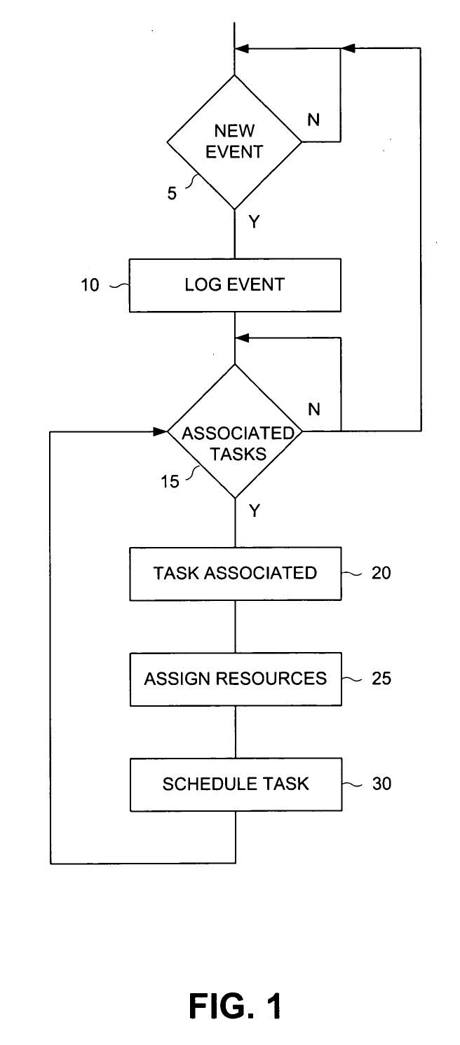

FIG. 1 is a flow diagram that depicts one illustrative method for managing projects by responding to events. The method of the present invention provides for recognizing the occurrence of a new event (step 5). Once an event is recognized, it may be recorded (step 10). The present method provides that each type of an event that may be recognized may also have an associated event or group of tasks. Hence, if a particular event has an associated event (step 15), the method provides for spawning the new event that is associated with the recognized event (step 20). In an optional step, resources may be assigned to the newly spawned event (step 25). In yet an additional optional step, the method provides that the newly spawned event may also be scheduled (step 30). It should be noted that in the context of the present method, an event is implicitly considered to have at least one associated task. Hence, when a new event is spawned, there is one associated task. Where more than one task must be performed as a responsive action to an event, the present method provides for spawning a “subproject”. A subproject may comprise a plurality of tasks that may be scheduled sequentially and may consider precedence and succession of tasks and the availability of resources.

According to one derivative of the present method, additional automated functionality may be invoked when a particular type of event is recognized. In one illustrative example, the method of the present invention of may cause the sequence of directives to be executed when an event is recognized. Such a sequence of events, which is also known as a “macro”, may provide automation of tasks so that effective response may be performed in response to an event. Accordingly, a macro may be any executable software program that may operate on any data pertinent to the response.

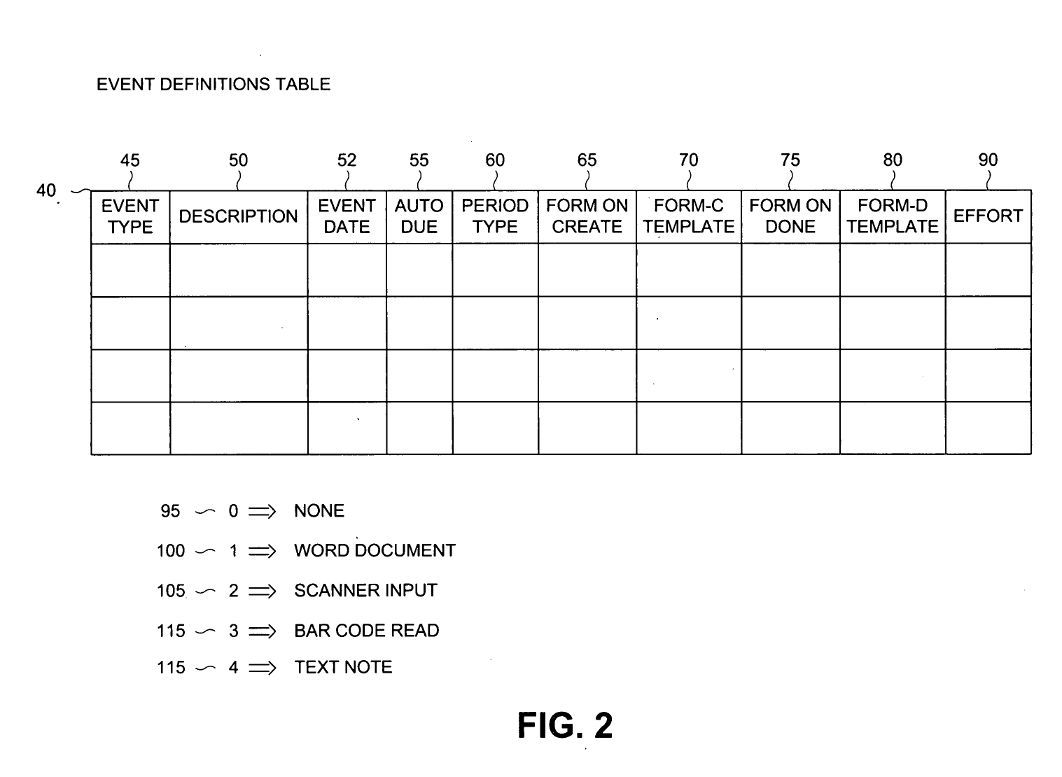

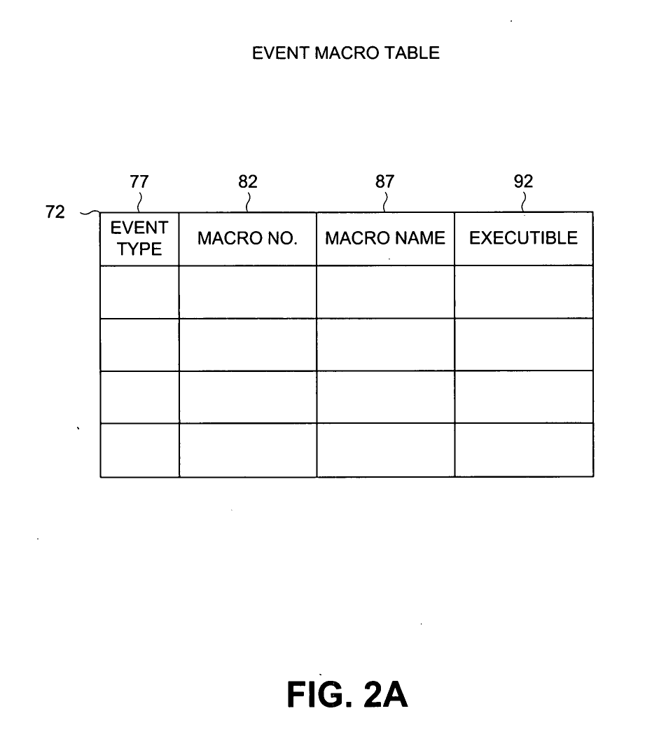

FIG. 2 is a pictorial representation of one illustrative structure for a table that may be used to store event definitions according to the teachings of the present invention. The present method may rely on information that may be stored in a plurality of tables in a database. The present method may provide for the use of an event definitions table 40. In one variation of this method, the event definitions table 40 may comprise a field for an event type identifier 45. The present method may also rely on an event description that may be stored in a description field 50 comprising the event definitions table 40. In yet another variation of this method, the event definitions table may further comprise fields for an automatic due period 55. The due period may be distinguished by a period-type descriptor that may be stored a period-type field 60 that may further comprise the event definitions table 40.

In contrast to know project management methods, when a particular event occurs, a response date for that event may be established by the automatic due period that may be stored in the automatic due period 55. Hence, a responsive action may be scheduled by adding the automatic due period for a particular event to the date on which the event occurred. The automatic due period stored in the automatic due field 55 may be any duration of time such as minutes, hours, days, months or years. The type of the period may be stored in the period type field 60. For instance, if the automatic due response period for a particular event is 30 days, the value stored in the auto due field 55 would be “30” and the value stored in the period type field 60 may be “D” to indicate “days”. All of these examples of duration types are provided for illustration purposes only and are not to be construed as limiting the scope of the present invention.

According to one illustrative method of the present invention, a particular type of event may require the generation of a correspondence either when the event is first recognized or when the responsive action is completed. The method of the present invention provides that various types of information may be gathered or generated when a particular event occurs. Hence, the event definitions table 40 may further comprise fields that may be used to store indications for the type of information that must be generated or acquired when an event is first recognized and/or when a responsive action is completed. These fields may comprise a form-on-create field 65 and a form-on-done field 75, respectively. Typically, these fields are used to store a document type identifier.

In one illustrative use case, a word processing document may be represented by a value of “1” stored in either of these fields. An event may require acquisition of an image when the event is first noted or when the responsive action is completed. Hence, scanner input may be represented by a value of “2” stored in either of these fields. Likewise, a bar-code may need to be read; form type “3”. A simple textual note may need to be attached to the event. This would be represented by a value of “4” in either of the fields. Optionally, the event definitions table 40 may also comprises a template field (70, 80) that may be used in conjunction with the form-on-create field 65 or the form-on-done field 75. Separate template fields may be used to store templates that may be used to govern the generation of a form or the acquisition of information upon recognition or completion of an event.

Another illustrative use case may be the occurrence of a particular event that only requires the generation of a letter to a client as a responsive action. In such a case, the record used to define the particular event may comprise a “1” value stored in the form-on-create field 65 to indicate that a word processing document must be created in response to the event. The template field 70 for the form-on-create field 65 may comprise a definition of the content of the word processing document and any information that must be gathered from a database.

FIG. 2A is a pictorial representation of a table that may be used according to the teachings of the present method to define executable macros that may be spawned in response to a particular event. According to the method of present invention, an event may have associated with the one or more automation macros. These macros may be executable software programs that may operate to on data pertinent to the event. This illustrative example method may rely on an event macro table 72. The event macro table 72 may comprise an event type field 77, a reference to executable field 92, and, optionally, a macro name field 87. According to this method, or more than one macro may be spawned in response to a particular type of event, the event macro table 72 may further comprise a macro number field 82 which may be used to store distinguishing values for records pertaining to the same type of event.

According to this variation of the inventive method, the identifier of a particular type of an event may be stored in the event type field 77 comprising the event macro table 72. The method of the present invention may allow a logical named to be affiliated with a particular macro. This may be optionally stored in the macro named field 87. The reference to executable field 92 may be used to store a reference to executable file comprising the macro. This reference may comprise a directory path name and a filename. According to the method of the present invention, a macro may comprise the stand-alone executable program that may be written in any convenient programming language. The macro may also comprises a commercially available application program that may be launched using a command line. In such a case, the reference to executable field 92 may be used to store a command line that may be used to launch a commercially available application. According to one variation of the present method, stand-alone applications such as word processors, spreadsheets and the like, may be launched using a command line wherein the command line may cause the stand-alone application to execute a high-level macro language program.

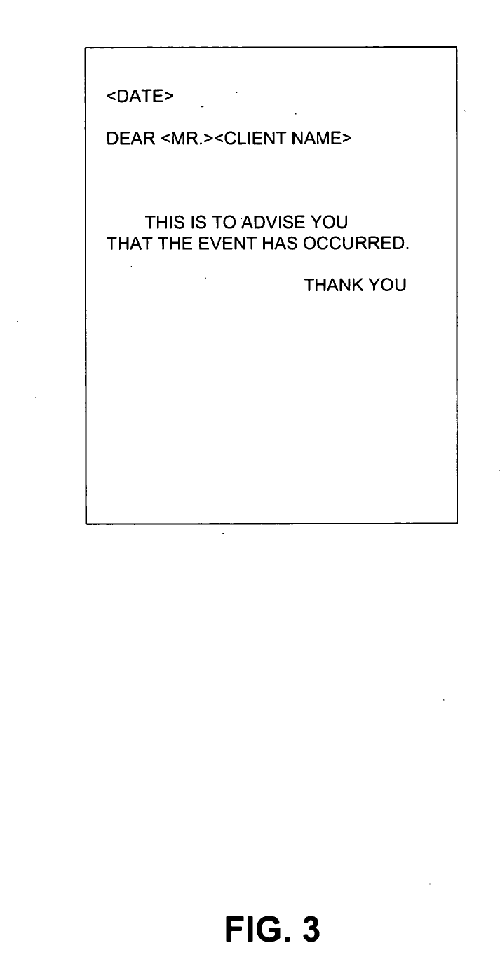

FIG. 3 is a pictorial illustration of one illustrative structure for a template defining a word processing document. According to this illustrative use case, database records may be accessed by using special delimiters such as a less-than sign (<) and a greater-than sign (>). According to this illustrative example, the content of a named field may be retrieved from the database when the form letter is generated. Other information may be provided in the template stored in the template field 70 for the form-on-create field 65 that may then appear in the completely generated form letter. This example use case is provided only to make clear the use of the form-on-create field 65 and its associated template field 70 and is not intended to limit the scope of the present invention. The form-on-done field 75 and its associated template field 80 may be used in an analogous manner when a responsive action to an event is completed.

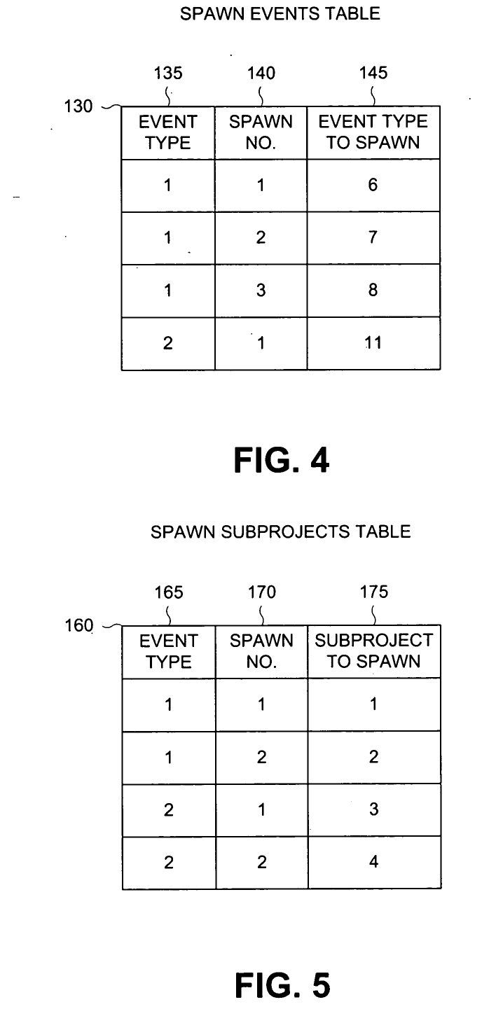

FIG. 4 is a pictorial representation of a one example structure of a table that may be used to define the types of events that may be spawned in response to a particular event. The method of the present invention may use a spawn events table 130 to define what type of events must be spawned in response to a given event. The spawn events table 130 may comprise fields for an event type 135 and an event type to spawn field 145. In the case where more than one event must be spawned for a particular event, the spawn events table 130 may further comprise a spawn number field 140.

In one illustrative use case, as depicted in the figure, an event type designated as event type “1” may require three different types of events to be spawned when it is recognized. According to this illustrative use case, the event type “1”, once recognized, will require an event type “6”, type “7”, and type “8” to be spawned. The records that may be stored in the spawn events table 130 for these three types of spawned events may be distinguished according to the spawn number field 140.

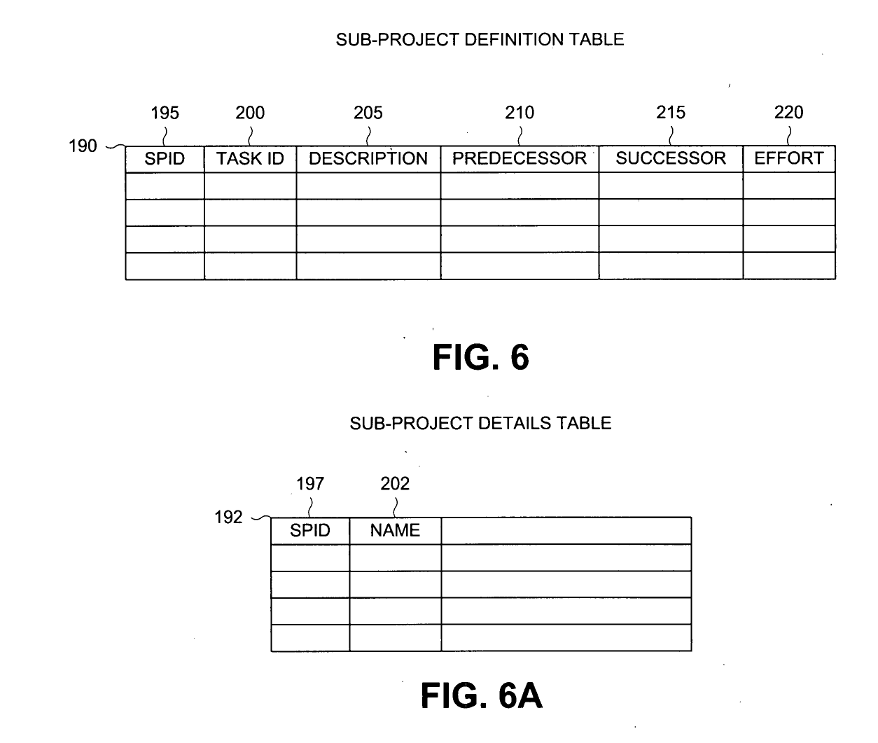

FIG. 5 is a pictorial representation of one possible structure for a table that may be used to define the types of subprojects that may be spawned in response to a particular type of event. The method of the present invention may use a spawn subprojects table 160 to store definitions of subprojects that need to be spawned in response to a particular event. Typically, the spawned subprojects table 160 comprises an event type field 165 and a subprojects to spawn field 175. The spawn subprojects table 160 may further comprise a spawn number field 170 that may be used to distinguish records in the table when a particular event has more than one subproject associated with it.

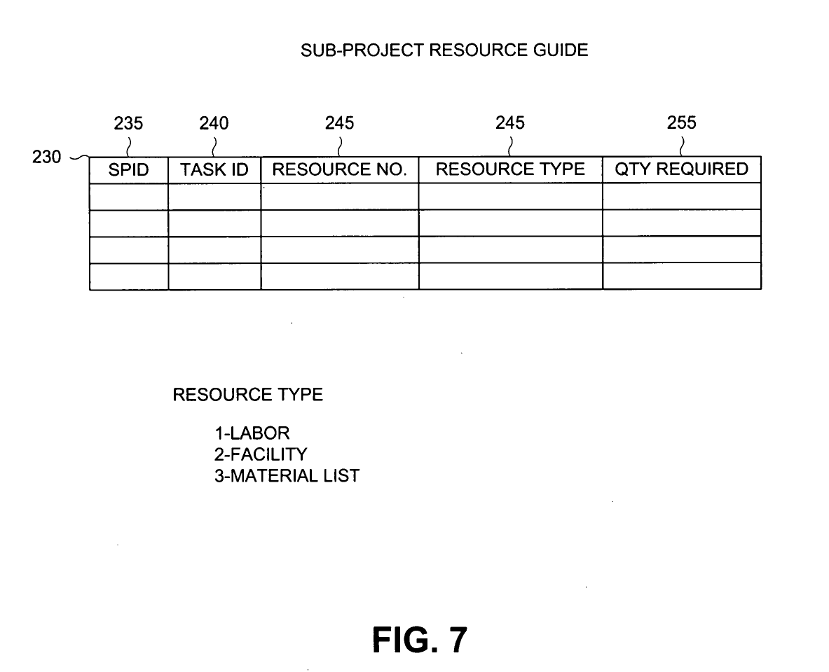

FIG. 6 is a pictorial representation of one illustrative structure for a table that may be used to store definitions of subprojects according to the teachings of the present invention. According to one variation of the present method, subprojects may be defined as a collection of individual tasks that may be executed in response to an event. The subproject definition may be stored in a subproject definition table 190. The subproject definition table 190 may comprise fields for storing a subproject identifier 195, a task identifier 200 and a task description 205. The subproject definition table 190 may further comprise fields for storing the identifier of a proceeding task 210 and a succeeding task 215. In some variations of the present method, the subproject definition table 190 may further comprise an effort field 220 that may be used to store a standard effort value to accomplish the task defined by a particular record in the subproject definition table 190.

According to a derivative of the present method, a subproject identifier may be created and stored in the subproject identifier field 195 in one or more records stored in the subprojects definition table 190. For each record comprising a particular subproject, one or more task identifiers may be stored in the task identifier field 200 along with the description for the task in the description field 205. In yet a different variation of the present method, each task may have an associated predecessor task and/or successor task. The task identifier for the predecessor task may be stored in the predecessor field 210 whereas the task identifier for the successor task may be stored in the successor field 215 in a particular task record stored in the subproject definition table 100.

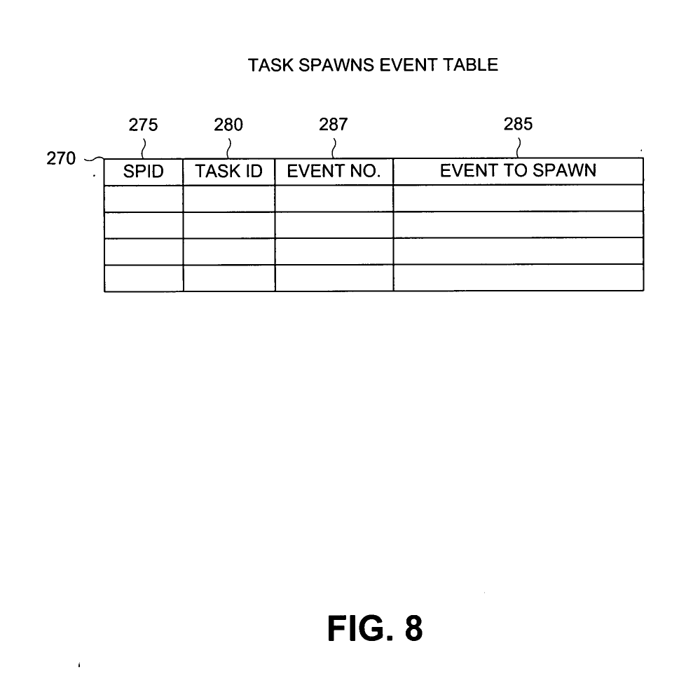

FIG. 7 is a pictorial representation of one possible embodiment of a table that may be used to store resource requirements for tasks defined according to the teachings of the present invention. According to one variation of the present method, resources that are necessary to accomplish a particular task may be enumerated in a subproject resource guide table 230. The subproject resource guide table 230 may comprise a subproject identifier field 235, a task identifier field 240, a resource number field 245, a resource type field 250 and a quantity required field 255. The method of the present invention may associate resources of a particular type by storing the identifier of a subproject and of a task in the subproject identifier field and the task identifier field 240, respectively. Where more than one resource must be applied to a particular task, records in the subproject resource guide table 230 may be distinguished by the value stored in the resource number field 245.

The amount of a particular resource that may be needed to accomplish the task may then be stored in the quantity required field 255. The type of resource may be indicated by a value stored in the resource type field 250. According to the method of present-invention, the duration of a particular task may be ascertained by retrieving an effort value for the task from the effort field 220 comprising the subproject definition table 190 and applying the availability of resources enumerated in the subproject resource guide table 230.

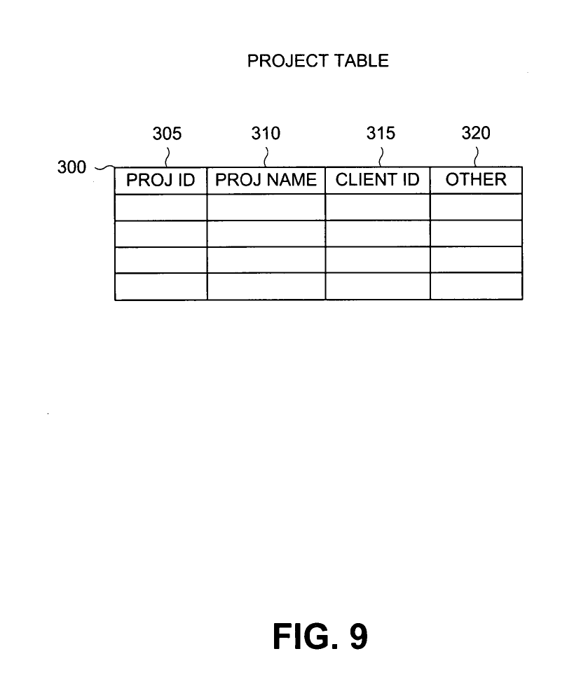

FIG. 8 is a pictorial representation of one illustrative structure of a table that may be used to define the types of events that may be spawned when a task comprising a subproject is initiated or completed. According to one variation of this method, an event may be spawned at any point in the execution of a task. The method of the present invention provides that when any particular task is completed, a new event may need to be spawned.

According to one variation of the present method, a task spawns event table 270 may be used to define what type of an event should be spawned when a particular task is completed. The task spawns event table 270 may comprise a subproject identifier field 275, a task identifier field 280 and an event to spawn field 285. Where the completion of a particular task requires spawning of more than one event, records in the task spawns event table 270 may be distinguished according to a value stored in an event number field 287 that may further comprise the task spawns event table 270. For any particular task comprising a subproject, as identified by a value stored in the task identifier field 280 and the subproject identifier field 275 in a particular record stored in the task spawns event table 270, an event type may be specified by storing the identifier of the event in the event to spawn field 285 in the same record.

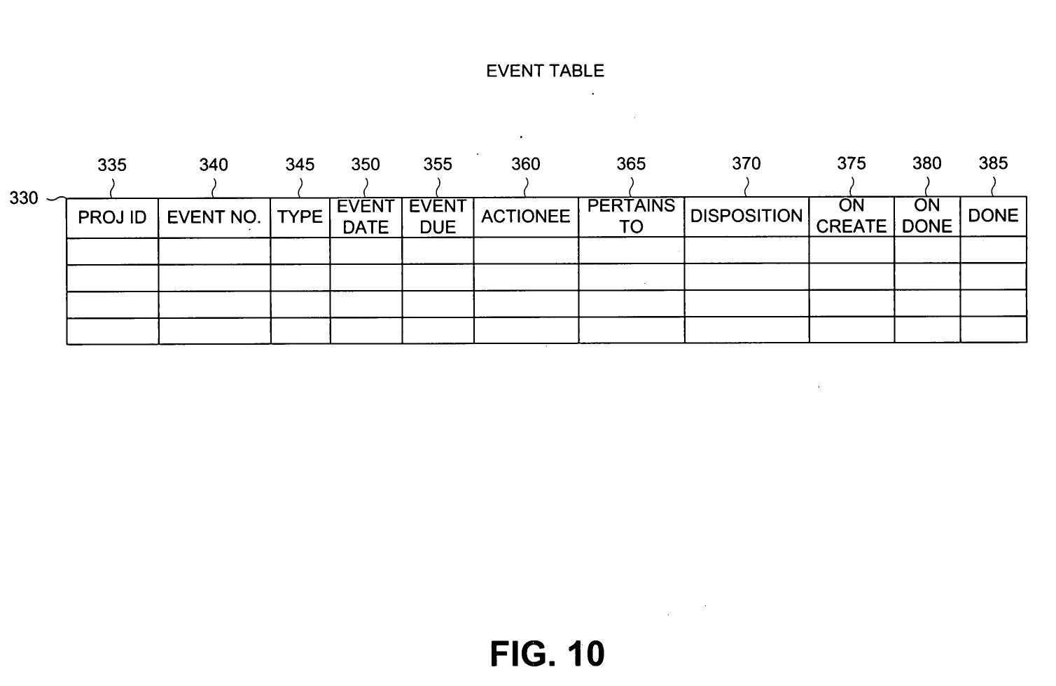

FIG. 9 is a pictorial representation of one possible structure of a project table that may be used to define projects that may be managed by a project management system commensurate with the teachings of the present invention. According to the method of this invention, a new project may be identified by storing information about the project in a project table 300. The project table 300 typically comprises a project identifier field 305 and a project name field 310. The project table 300 may further comprise a client identifier field 315. Other information may also be stored in other fields 320 that may comprise the project table 300.

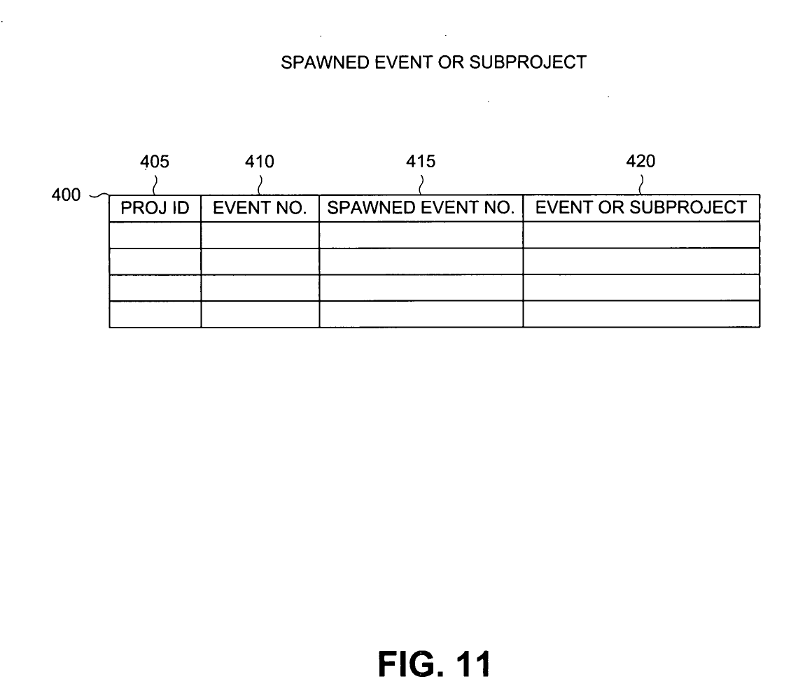

FIG. 10 is a pictorial representation of one example structure of an event table that may be used to record events as they occur and are thus recognized in accordance with the teachings of the present invention. One variation of the present method provides that each event, once recognized, should be recorded. In an operational system that implements the teachings of the present invention, the event may be recorded in an event table 330. The event table may comprise a project identifier field 335, an event identifier field 340 and an event type field 345. As events are recognized, new records may be created in the event table 330. Once a new record is created, a project identifier reflecting the project to which the event pertains may be stored in the project identifier field 335 of the new record. According to one variation of the present method, the type of event recognized by the method may be stored in the event type field 345. In one variation of this method, the type of event that may be recognized may be relationally linked to event types enumerated in the event definitions table 40. Hence, this variation of the inventive method may enforce referential integrity between the event type field 345 and the event definitions table 40.

In yet another variation of the present method, the event table may further comprise an event date field 350. According to this method, the date upon which the event occurred may be stored in the event date field 350. In yet another variation of the present method, the event table may further comprise an event due field 355. In this variation of the method, the event due date may be calculated by retrieving an automatic due period from the automatic due field 60 comprising the event definitions table 40 indexed through the event type field 45. This index typically reflects the event recorded by the value stored in the event type field 345 of the new record created in the event table 330. Once the automatic due period is retrieved from the event definitions table 40, it is added to the event date stored in the new records event date field 350. The resulting date may then be stored in the event due field 355 comprising the new record for the newly recognized event. In another variation of this method, the type of automatic due period may be determined by retrieving a period type value stored in the event definitions table 40; period type field 60.

According to yet another variation of the present method, the event table 330 may further comprise an actionee field 360. The actionee field 360 may be used to identify an individual or organization that may be responsible for responding to the event. One additional variation of the present method provides for a disposition field 370 that may further comprise the event table 330. According to this variation, the disposition field 370 may be used for textual comments pertaining to the event.

Further illustrating the present method, when an event is recognized information may need to be generated or acquired. Further, when an event is completed (i.e. a responsive action to the event is accomplished) information may also need to be generated or acquired. In this variation of the inventive method, the event definitions table 40 may be consulted by indexing through the event type field 45 of that table according to the type of event recorded in the newly created recorded the event table 330. In order to determine if a particular event requires generation or acquisition of information, the event definitions table form-on-create field 65 may be consulted. According to one variation of this method, a null value may be stored in the form-on-create field 65 for a particular event type. In this case, no generation or acquisition of information is required when the event is first recognized. If, on the other hand, the value stored in the form-on-create field 65 for a particular event type is non-null, information may need to be generated or acquired.

In the case were information must be generated, such as the creation of the word processing document, the form-on-create field 65 for the event recorded may be set to a value of “1”. This value setting is for purposes of illustration only is not meant to limit the scope of the present invention. In this case, the event definitions table 40 may be further consulted to discover a document template that may be indicated in the form template field 70 associated with the form-on-create field 65. Once the word processing document is created, it may be stored in its entirety in an on-create field 375 that may further comprise the event table 330. In an alternative method, the word processing document may be stored on computer readable media such as a file managed by a disk operating system. In this case, the on-create field 375 may be used to store a reference to the word processing document such as a directory path and filename.

Where information must be acquired upon recognition of a particular event, the form-on-create field 65 may indicate the need to acquire information. In one illustrative use case, the value stored in the form-on-create field 65 particular event may be “2”. Again, this value setting is for illustration purposes only is not meant to limit the scope of the present invention. In this use case, the value of “2” may indicate that a document needs to be scanned and saved for future reference. In this case, the method of the present invention may provide that a scanner driver be initiated and a scanned image of a document may be retrieved from the scanner driver. The scanned image may then be stored in the on-create field 375 in the newly created record stored in the event table 330. In yet another alternative variation of this method, the scanned image may be stored on computer readable media such as a file managed by a disk operating system. This case, the on-create field 375 may be used to store a reference to the stored scanned image file such as a directory path and filename.

According to the method of present invention, information may be generated and/or acquired when an event is completed. In this case, files such as word processing documents that are generated upon completion of events may be stored in the on-done field 380 in the newly created record associated with a recognized event. Likewise, information that is acquired such as scanned image files, may be stored in the on-done field 380. In each of these use cases, the on-done field 380 may also be used to store a reference that may be used to access a file stored on computer readable media in a manner analogous to that described above; i.e. when a new event is recognized.

In yet another variation of the present method, the event table 330 may further comprise a done field 385. This field may be a flag that may be used to indicate whether a response to a particular event has been accomplished. Typically, this field is a Boolean flag.

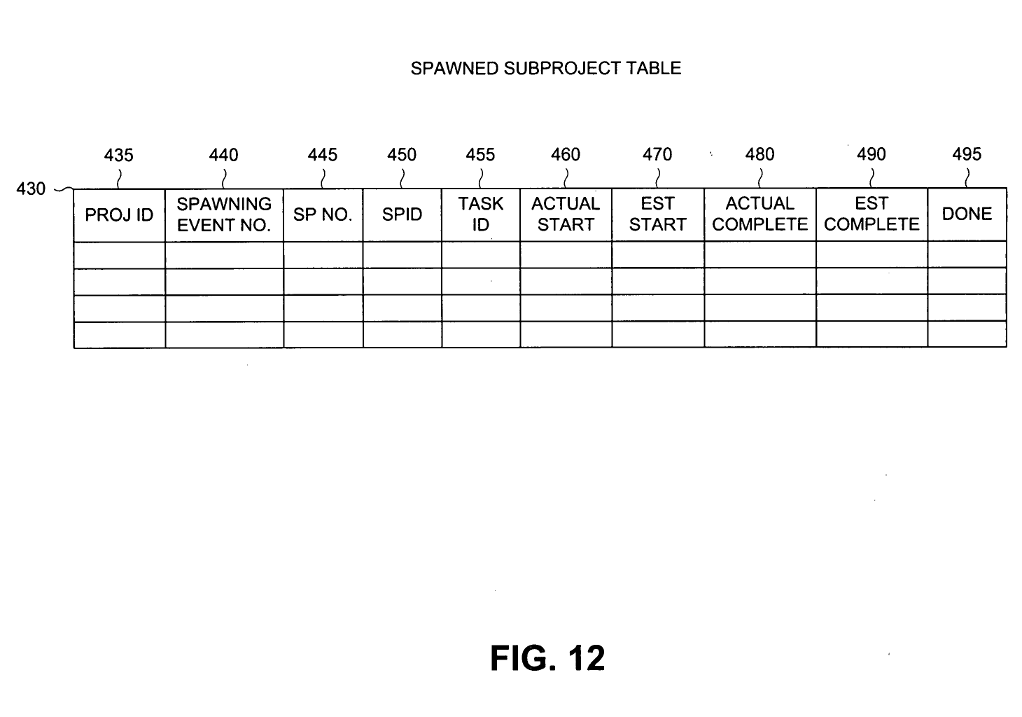

FIG. 11 is a pictorial representation of one illustrative structure of a table that may be used to record a hierarchy relationship between a newly recorded event and a spawned event associated with the newly recorded event. A key feature of the present method is that of spawning a new event or subproject in response to a newly recorded event. To further illustrate the present method, as an event is recorded the method provides for discovery of events or subprojects that may be associated with the newly recorded event. As already taught, recognition of a new event may result in the creation of a new record in the event table 330. The type of event, as indicated by the value stored in the event type field 345 of the newly created record, may be used to index either the spawned events table 130 or the spawned subprojects table 160.

In the instant case were a particular event has an associated event-to-spawn defined in the spawn events table 130, a record in the spawn events table 130 will be found wherein the event type field 135 is equal to the event type (i.e. the index value) of the event stored in the newly created record. According to this method, a new record will be created in events table 330 and a new event will be recorded in the new record according to the event type specified in the spawn events table 130 in the event-to-spawned field 145. Of course, the new record project identifier field 335 will be set to reflect the project to which the newly spawned event pertains. In the event that more than one event is to be spawned in response to the recognition of a particular event, more than one record will exist in the spawn events table 130 wherein the event type field 135 is equal to the recognized event. In such a case, the method provides that the plurality of records may be distinguished from each other using the spawn number field 140 comprising the spawn events table 130. It is always important to note that a newly spawned event may implicitly define a task. This task may comprise a responsive action to the event that initiated the spawning action.

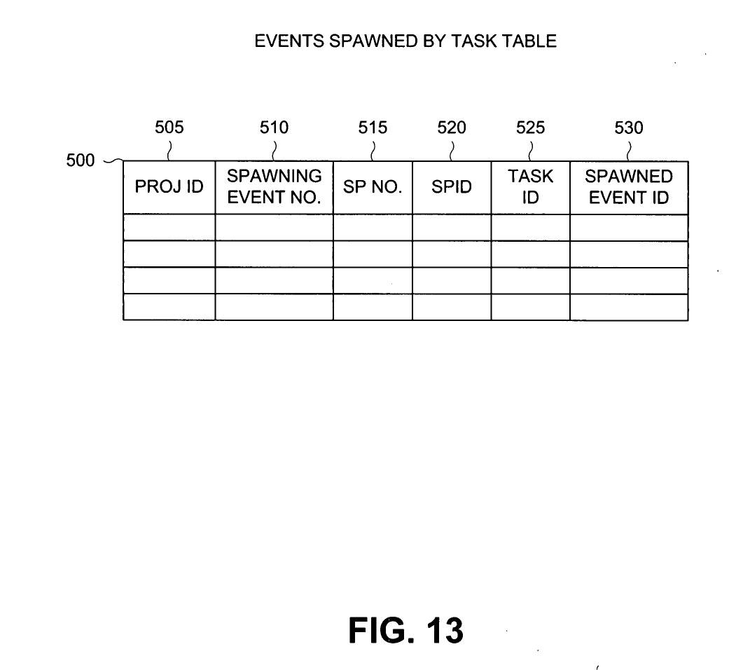

FIG. 12 is a pictorial representation of one illustrative embodiment of a table that may be used to record tasks comprising subprojects that may be spawned according to the teachings of the present method. As already discussed, an event may spawn a subproject. According to one variation of the present method, when a subproject is spawned, individual tasks comprising the subproject may be discovered by consulting the subproject definition table 190. A subproject is normally spawned in response to an event when the subproject identifier for a particular subproject is found in the subproject to spawn field 175 of the spawned subprojects table 160 for the event type. Using the subproject identifier as an index, all of the tasks comprising a subproject may be discovered by consulting the subproject definition table 190. All records within the. subproject definition table 190 wherein the subproject identifier field 195 is equal to the index correspond to individual tasks that make up that particular subproject.

For each identified task associated with a newly spawned subproject, one illustrative variation of the present method provides for the creation of a new corresponding record in the spawned subproject table 430. Hence, a new record is created in the spawned subproject table 430 for every task associated with the newly spawned subproject. According to one variation of this method, the spawned subproject table 430 may comprises a project identifier field 435, a spawning event number field 440, a subproject number field 445, a subproject identifier field 450 and a task identifier field 455. For every new record created in the spawned subproject table 430, the project identifier field 435 and the spawning event number field 440 are used to store the project identifier and number of the event that spawned the subproject and may be used to relationally link the event table 330 to the spawned subproject table 430. In situations where more than one subproject may be spawned in response to a particular event, the subproject number field 445 may be used to distinguish records among various subprojects spawned in this manner.

For each new record created in the spawned subproject table 430, the subproject identifier field 450 and the task identifier field 455 are typically populated with values retrieved from the subproject identifier field 195 and the task identifier field 200 from the subproject definition table 190, respectively. It yet another variation of the present method, the spawned subproject table 430 may further comprise fields for an estimated start 460 and an estimated completion 480. According to one variation of this method, the estimated start field 470 may be populated based on the date upon which the task was spawned. It yet another variation of this method, the estimated start date field 470 may be used to store a calculated value based on the estimated completion date of any predecessor task that may be defined for a particular subproject identifier/task identifier in the subproject definition table 190. The method of the present invention may also be adjusted to provide for the capture of actual start and completion dates. These may be stored in an actual start field 460 and an actual completion field 480 that may further comprise the spawned subproject table 430. In yet another variation of the present method, the spawned subproject table 430 may further comprise a done field 495 that may be used to indicate that a particular task has been completed.

According to yet another illustrative variant of the present method, the estimated start and completion time for a particular task may be ascertained by determining if sufficient resources are available to support the task. According to this illustrative method, the subproject identifier and task identifier may be used to select records from the subproject resource guide table 230. Records stored in the subproject resource guide table 230 that have a subproject identifier field 235 and a task identifier field 240 equal to the selection criteria may be identified and then used to determine what types of resources must be available before the task may be initiated. Where more than one resource is required for a particular task comprising a particular subproject, the subproject resource guide table 230 provides a resource number field 245 for distinguishing amongst a plurality of records having identical subproject identifier and task identifier values. The subproject resource guide table 230 may then be used to retrieve a resource type from the resource type field 250. In yet another variation of this method, the subproject resource guide table 230 may also be used to determine the quantity of a particular resource required to support a particular task. This quantity value may be retrieved from a quantity required field 255 that may further comprise the subproject resource guide table 230.

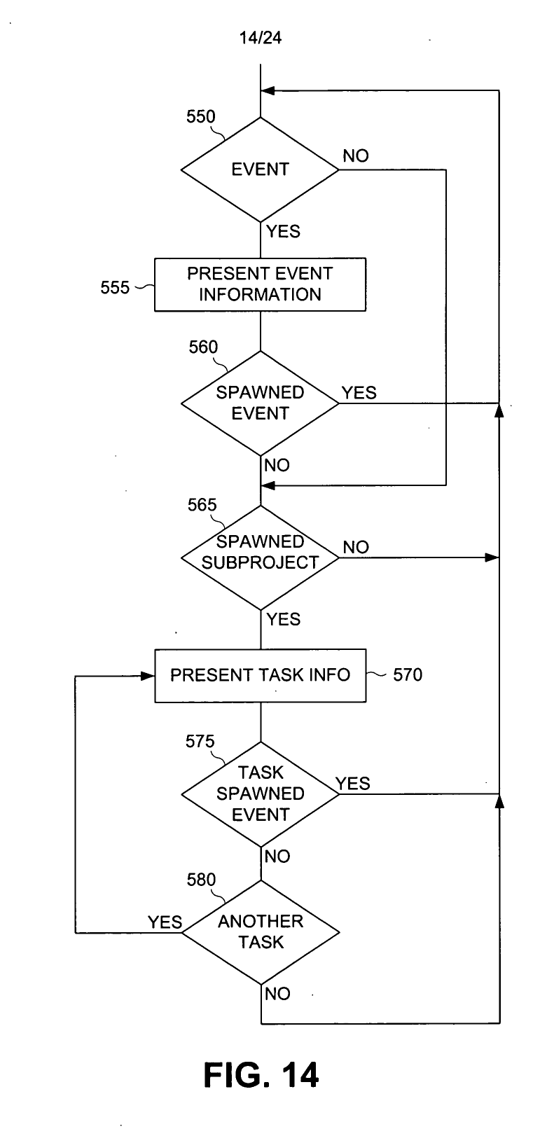

FIG. 13 is a pictorial representation of one possible structure of a table that may be used according to the present method to record the spawning of an event by a task comprising a subproject. According to one variation of this method, an event may be spawned by a task by creating a new record in an events spawned by task table 500. The events spawned by task table 500 may comprise a project identifier field 505, a spawning event number field 510, spawning subproject number field 515, a subproject identifier field 520 and a task identifier field 525. Upon spawning a new event, the method of the present invention provides that the project identifier, the number of the event that originally spawned the subproject comprising the spawning task, the subproject number spawned by the event, the subproject identifier and the task identifier all be used to index a spawned event. These are typically stored in fields comprising the events spawned by task table 500 as described above. The identifier of the event spawned is typically stored in a spawned event identifier field 530 further comprising the events spawned by task table 500.

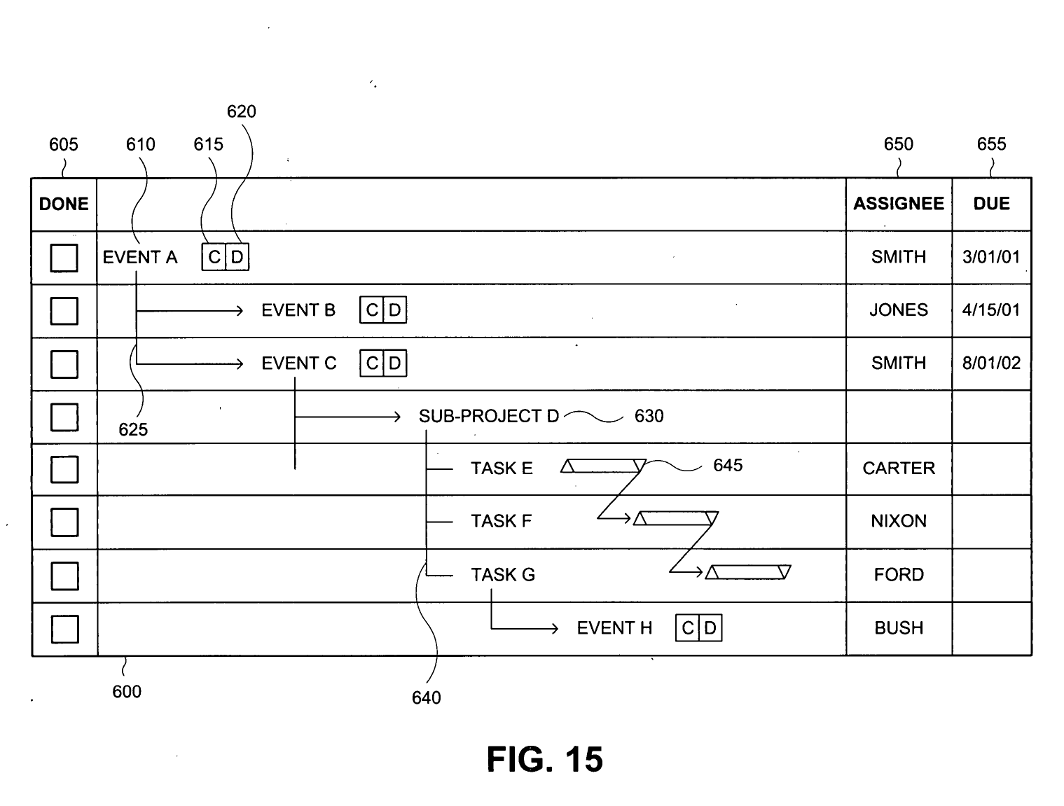

FIG. 14 is a flow diagram that presents one possible series of steps for reporting task progress illustrative of the present invention. As events are stored in a database according to the method of the present invention, it may be necessary to create a report that depicts the status of the events and spawned descendant events or subprojects thereof. Accordingly, a report may be generated by first determining if there is an event stored in the database (step 550). If a record representing the event is found in the database it may be presented to a user (step 555). After the information pertaining to the event is presented to a user, one alternative of this method provides for determining if there are any spawned events for the particular record already presented to the user. If there is a spawned event (step 560), information pertaining to the spawned event must be presented to the user. This is typically accomplished by returning to the beginning of the flow diagram (step 550) because each event may have descendant spawned events; thus forming a hierarchy. If there are no spawned events, another alternative method provides for determining if there is one or more spawned subproject associated with the event (step 565). Where a subproject is found, information about the subproject may be presented to the user. Also, information pertaining to a first task comprising the subproject may also be presented to the user (step 570). For any given task, if the task spawned an event an additional hierarchical tree of events and subprojects may have been recorded in the database. In this case, if the task spawned an event (step 575) the method of the present invention returns back to the beginning of the flow diagram to determine if an event spawned by the task exists (step 550). This process may be repeated for other tasks that may comprise a spawned subproject (step 580).

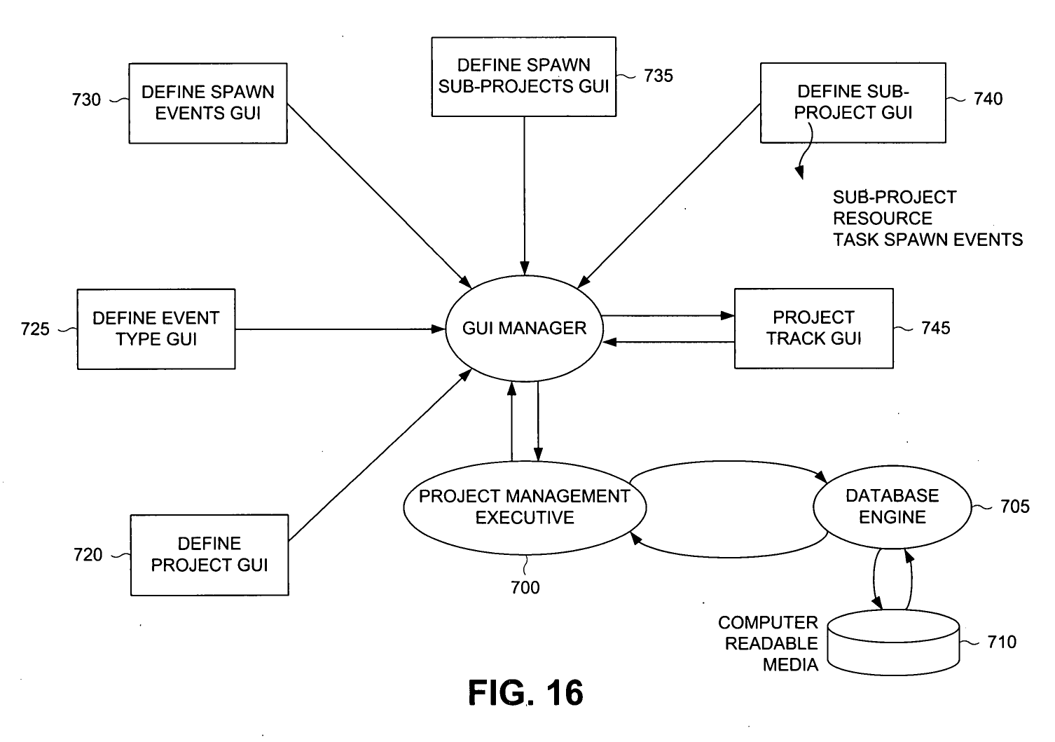

FIG. 15 is a pictorial representation of one possible structure for a report that may be used to present task progress according to the teachings of the present method. In order to record a spawning action, the present method provides for the use of a spawned event or subproject table 400. According to one variation of this inventive method, the spawned event or subproject table 400 may comprise a project identifier field 405, an event number field 410, a spawned event number field 415 and an event/subproject field 420. According to this method, whenever a new event or subproject is spawned, a new record is created in the spawned event or subproject table 400. The project identifier field 405 in the new record is set to reflect the project to which the newly spawned event pertains. The event number field 410 of the spawned event or subproject table 400 is set to indicate the parent event that caused the new event to be spawned.

The progress of events and/or subprojects may be reported by consulting the project table 300 and the events table 330. For any event recorded in the event table 330, a report may be generated by creating a single line 600 representing the event. Hence, for any event, a single line may comprise an event description 610. In order to form the event description, the method of the present invention may consult the events table 330 to determine the type of event as stored in the event type field 345 for any particular record. In order to discriminate amongst various projects that may be reflected in the events table 330, the project identifier field 335 may be used to select only those records pertaining to a particular project. Once the type of event is identified by retrieving the value stored in the event type field 345, it may be used as an index into the event definitions table 40. The description of the event type may then be retrieved from, the description field 50 comprising the event definitions table 40 and presented in the report field 610.

According to one variation of the present method, a report line 600 may further comprise an “on-create” icon 615. The report line 600 may further comprise an “on-done” icon 620. The method of the present invention may further consult the event table 330 to determine if the on-create field 375 and the on-done field 380 of a particular record contained non-null values. In this case, the on-create icon 615 and/or the on-done icon 620 may be integrated into the report line 600 for a particular record. If a user selects either of these icons, the method of the present invention provides for presentation of a correspondence file referenced by the on-create field 375 and/or the on-done field 380 of the particular record.

The present method also may provide for presentation of an actionee and/or a due date for an event represented by a particular record stored in the event table 330. In these variations of the present method, the name of an actionee may be discovered from the actionee field 360 for a particular event. The due date may likewise be obtained by retrieving the value of the due-date field of the particular record. The retrieved values may then be presented in the report line 600 for the event in an assignee field 650 and/or a due-date field 655 that may further comprise the report line 600.

The reporting scheme taught by the present method also consults the contents of the spawned events or subprojects table 400. A record of events or subprojects spawned by a particular event may be discovered by indexing the spawned events or subprojects table 400 through the project identifier field 405 and the event number field 410. Any given set of records identified in this manner will represent events or subprojects that have been spawned by a particular parent event; these are sometimes referred to as descendent events or subprojects. In this case, a new report line 600 may be generated for a descendant and will typically comprise a hierarchy indicator 625. The report line 600 may then further comprise an event description that may be ascertained in a manner like that used to determine the event description for a parent event as already discussed supra. The report line 600 for a descendant may also comprise on-create and on-done icons. The report line 600 for a descendant may further comprise an assignee and/or a due date. These may be presented by again consulting the event table 300 in a manner as discussed above for the parent event.

When the record found in the spawned events or subprojects table 400 indicates that a subproject has been spawned by a parent event, a subproject identifier line 630 may be presented in the report. Immediately after the subproject identifier line 630, the report method taught here may provide for presentation of separate report lines 600 for individual tasks that may comprise a subproject. In order to present these individual task report lines, the method of the present invention provides for consulting the spawned subproject table 430. By using the project identifier and number of the event that spawned the subproject, records pertaining to the individual tasks 455 comprising the subproject 450 may be retrieved from the spawned subproject table 430. For each task, the report line may comprise a task name field 641 followed by a hierarchy indicator 640. The name presented in the report for a particular task may be discovered by consulting the subproject definition table 190 by using the subproject identifier and task identifier as an index and retrieving the task description from the description field 205 for the indexed record.

For each task comprising a subproject, the method of the present invention provides for presenting the start and end times. In some variations of this method, this is accomplished using Gannt representations 645. By indexing the spawned subproject table 430 with the project identifier, spawning event number, subproject number, subproject identifier and task identifier, the start and end times for a task may be retrieved. The actual start and end may be retrieved from the actual start field 460 and the actual complete field 480 and estimated start and end from the estimated start field 470 and the estimated completion field 490. These values may then be used to drive the Gannt representation 645.

One illustrative variation of the present method provides for consulting the events spawned by task table 500 to identify if a subproject task has spawned an event. Using the project identifier, spawning event number, subproject number, subproject identifier and task identifier as indices, a spawned event may be discovered by its event identifier. Information pertaining to the spawned event may then be retrieved from the events table and presented in a report comprising a report line for the spawned event akin to the description above.

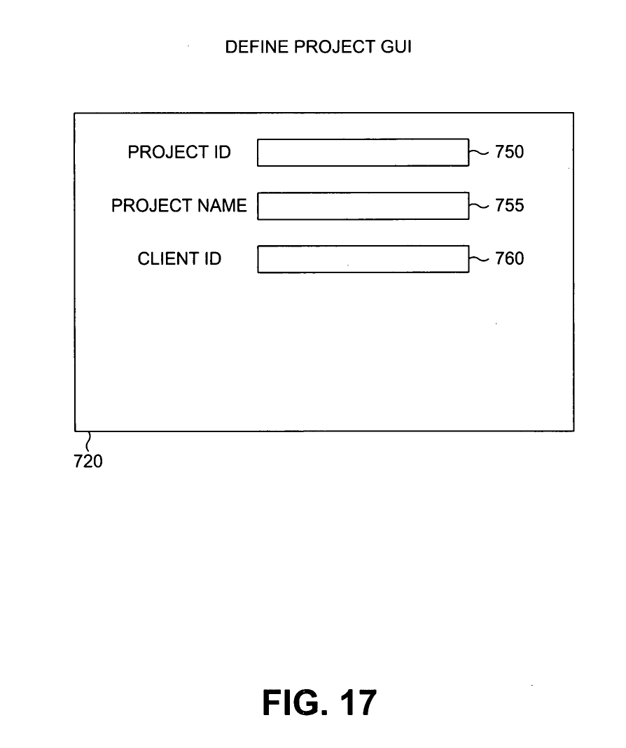

FIG. 16 is a pictorial representation of one possible structure of a software program that embodies the teachings of the present method. In practice, the method of the present invention may be embodied in a project management executive 700 comprising a software program that may be executed by a processing device. Accordingly, the software program comprises a sequence of instructions that implement the present method and may be distributed by computer readable media. Hence, a processing device may retrieve the sequence of instructions from the computer readable media, store the instructions in memory and execute the instructions sequence.

According to one embodiment of the present invention, the project management executive 700 may work in conjunction with a database engine 705 that is also a software program and that may further comprise the invention. Typically, a database engine 705 will interact with a database that may be stored on computer readable media 710. According to one embodiment, the database engine 705 may be a relational database manager. In yet another embodiment of the present invention, the database manager may organize information in the database in tables commensurate with the teachings of the present method.

In order to provide interactivity with a user, the present invention may further comprise a software program module called a graphical user interface (GUI) manager 715. The GUI manager 715, according to one embodiment, may be responsible for presenting various user interfaces to a user in order to support the teachings of the present method. In one embodiment, the GUI manager 715 may create a define project GUI 720 and present this GUI to a user. Typically, the defined project GUI 720 may be used by a user to specify high-level information about a particular project that may be tracked according to the method of the present invention.

The GUI manager 715 in one illustrative embodiment of the present invention may further create a define event type GUI 725 and present this to the user. The define events type GUI 725 may be used by the user to specify different types of events that may be tracked by the method of the present invention.

In yet another example embodiment of the present invention, the GUI manager 715 may create and present to the user a define spawned events GUI 730 and/or a define spawned subproject GUI 735. In those embodiments of the present invention where the GUI manager 715 may create a define spawned events GUI 730, the define spawned events GUI 730 may be used by a user to specify what events should be spawned in response to a particular event. In a like manner, the user may specify what subprojects may be spawned in response to a particular event by using the define spawned subproject GUI 735.

In yet another alternative embodiment of a software program created according to the teachings of present invention, the GUI manager 715 may further create a define subproject GUI 740 and present this GUI to a user. The define subproject GUI 740 may be used by a user to specify what individual tasks may be associated with a particular subproject.

Using the define project GUI 720, the define event type GUI 725, the define spawned events GUI 730, the define spawned subproject GUI 735 and the define subproject GUI 740 a user can specify the structure of a project to be tracked by the method of the present invention. The GUI manager 715 may retrieve information provided by a user from each of these GUIs and provide this information to the project management executive 700. The project management executive 700 may then organize the information into various tables that may comprise a database stored on computer readable media 710 and managed by the database engine 705.

Once a project is defined according to events and responses to those events (i.e. the spawning of new events and/or subprojects) the user may tracked a project using a project tracking GUI 745 that the GUI manager 715 may further create and present to a user. Project tracking information may then be conveyed to the project management executive 700. The project management executive 700 may then use the project tracking information to manipulate tables comprising the database used to track a project. The database is ordinarily managed by the database engine 705 and stored on the computer readable media 710.

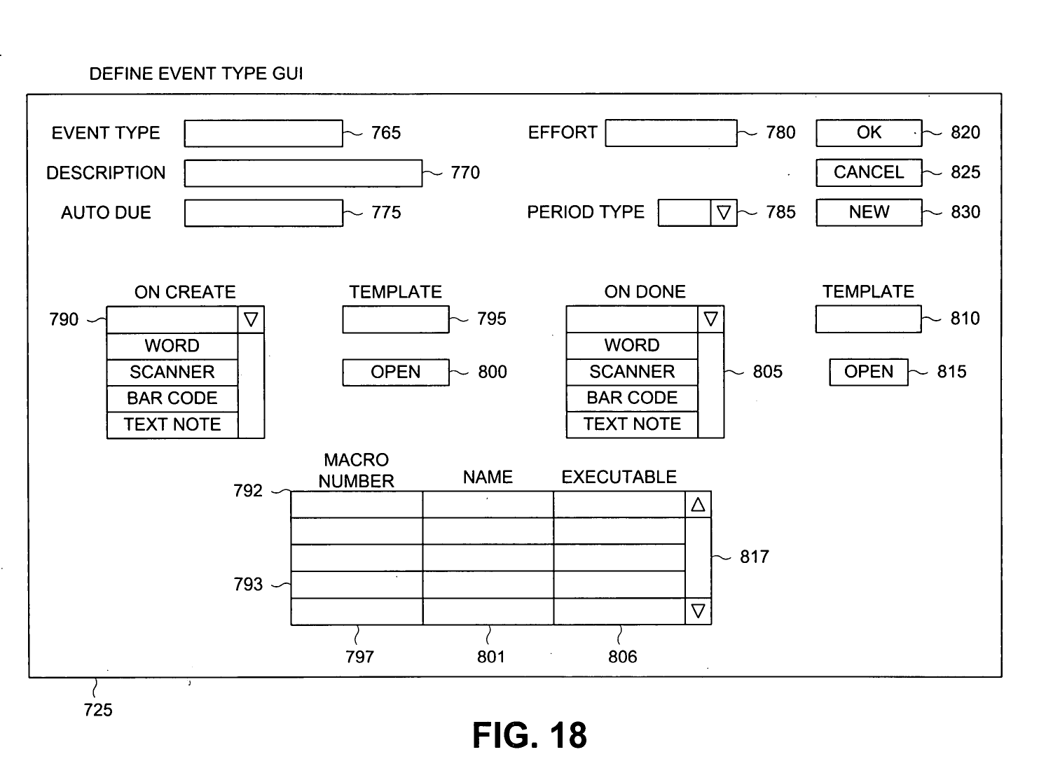

FIG. 17 is a representation of one illustrative example of a project definition GUI that may be created by the GUI manager comprising the present invention. According to one illustrative example, the GUI manager 715 of the present invention may create a define project GUI 720 that comprises a project identifier data entry control 750 and a project name data entry control 755. According to one alternative embodiment of the present invention. The define project GUI 720 may further comprise a client identifier data entry control 760.

According to this example embodiment of the present invention, the GUI manager may retrieve a project identifier and a project name from the define project GUI 720 once that information is entered by a user into the corresponding data entry controls. The GUI manager 715 may then forward this information to the project management executive 700. The project management executive 700 may then cause the database engine 705 to create a new record in a project table 300 that may comprise a database organized to manage projects according to the method of the present invention. Typically, the project table 300 will comprise a project identifier field 305 and a project name field 310. When the new record is created, the information obtained from the user will be stored in the project identifier field 305 and the project name field 310. In some embodiments, a client identifier may be retrieved from the define project GUI 720 and stored by the project management executive 700 in the client identifier field 315 of the newly created record.

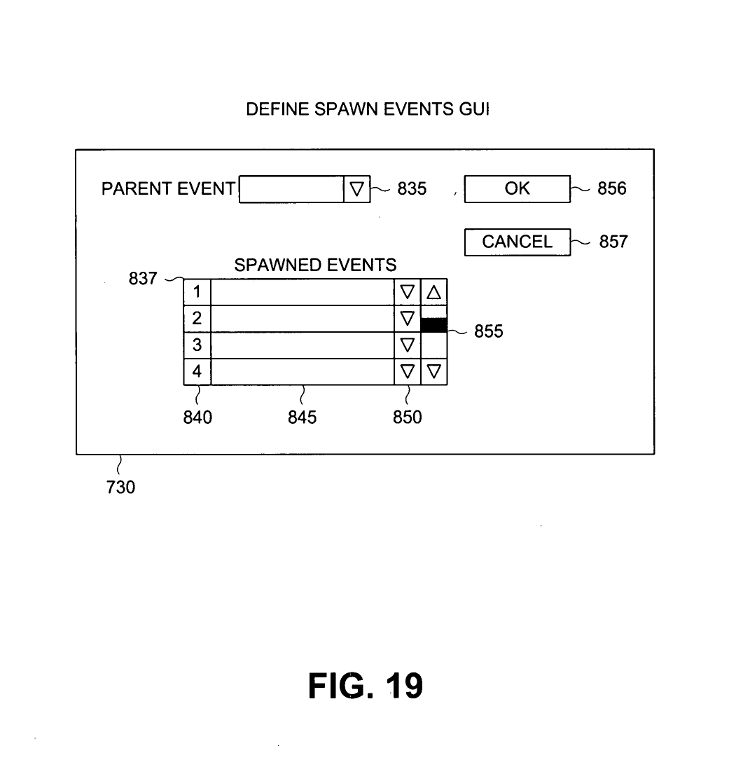

FIG. 18 is a pictorial representation of one possible embodiment of a define event type GUI that may be used by a software program that implements the method of the present invention. According to one example embodiment of the present invention, the GUI manager 715 may create a define event type GUI 725 comprising an event type data entry control 765 and an event description data entry control 770. Information entered into either of these controls by a user may be forwarded by the GUI manager 715 to the project management executive 700. The project management executive 700 may then cause the information to be stored in an event definitions table 40 that may further comprise a database managed by the database engine 705 for tracking projects according to the teachings of the present method. Typically, this information will be stored in a new record in the event definitions table 40. The event identifier and event description entered by a user will be stored in the event type field 45 and event description field 50 of the new record, respectively.

The event definitions table 40 may further comprise an event auto due field 55. The event definitions table 40 may further comprise an auto due period type field 60. According to one alternative embodiment of the present invention, the GUI manager 715 may further cause the define event type GUI 725 to comprise an auto due data entry control 775. The GUI manager 715 may further cause the define event type GUI 725 to further comprise an auto due period type data entry control. In some embodiments of the present invention, the GUI manager 715 may cause the auto due period type data entry control 785 to comprise a drop-down list. The drop-down list may be populated with a predetermined set of period types. These may include, but the scope of the present invention should not necessarily be limited to the period types “days”, “hours”, “months” and “years”.

When a user enters an auto due period in the auto due data entry control 775, this information will be forwarded to the project management executive 700. The project management executive may then store the auto due period in the auto due field 55 of the newly created record in the event definitions table 40. The period type may also be stored in the newly created record in the period type field 60. It should be noted, that period type that a user may enter may be constrained by entries contained in a drop-down list comprising the auto due period type data entry control 785 presented to the user by the GUI manager 715.

The GUI manager 715 may further cause the define event type GUI 725 to comprise an on create data entry control 790. The on create data entry control 790 may comprise a drop-down list. The drop-down list may include a collection of predetermined media types such as “word processing document”, “scanner input”, “barcode input” and “textual note”. This enumeration is meant to be illustrative of the concept of the present invention, and should not be the used to limit the scope of the present invention.

In yet another embodiment of the present invention, the define event GUI 725 may further comprise an on create template data entry control 795. According to one embodiment of this invention, the user may specify a media action to be taken on creation of an event. In such a case, the on create template data entry control 795 may be used to reference a template that may be used to format a particular media action. The reference may be in the form of a path name; directory path and filename. The reference may also be in the form of a binary record that may be edited from within the software program comprising the present invention. In this case, the define event GUI 725 may further comprise an open on-create template command button 800. The open on-create template command button 800 may be used to invoke an editor that may be used to create a template. In one embodiment, a command may be sent to the project management executive 700 when a user actuates the open on create template command button 800. In response to this command, the project management executive 700 may then invoke an external editor for the purpose of creating or modifying the template. In such case, the template may be stored as a binary image in the event definitions table 40. Hence, the template field for the on create form 70 may be of a binary large object (BLOB) data type that is capable of storing arbitrary binary data.

In one embodiment of the present invention, the event definitions table 40 may comprise a form on create field 65. Optionally, the event definitions table 40 may further comprise a form on create template field 70. User entry of a form on create may be retrieved from the on create data entry control 790, forwarded to the project management executive 700 and then stored in the on create field 65 in a record representative of an event definition specified by the user. User entry of a particular media action for the form on create may be constrained to values specified in a drop-down list that may comprise the on create data entry control 790. Those embodiments of the invention where a template may be specified for a particular media action, the template may be stored in the form on create template field 70 of a new record. Again, the user may specify either a reference to an external file or a template may be created in stored in the event definition table directly.

According to one alternative embodiment of the present invention, a separate media action may be specified for an event wherein the separate media action may be executed on completion of the event, i.e. “on-done”. In such a case, the define event type GUI 725 may further comprise an on done data entry control 805. An on done template data entry control 810 may further comprise the define event type GUI 725. An on done open template command button 815 may also comprise the defined event type GUI 725. A user may specify an on done media action using these additional GUI controls. In this case, the project management executive 700 may store information entered by the user in a form on done field 75 and a form on done template 80 field that may further comprise the event definitions table 40. The record representative of a new event definition may be used to store information in a manner analogous to that taught here for the “on-create” case.

In some embodiments of the present invention, the define event type GUI 725 may further comprise an effort data entry control 780. This data entry control may be used to obtain an effort amount from a user. Examples of effort amount may include man-hours to complete a particular event. This is just one example of an effort value is not intended to limit scope of the present invention. The effort value retrieved by the GUI manager 715 may be forwarded to the project management executive 700 and stored in an effort field 90 that may further comprise the event definitions table 40. Typically, the effort for a particular event specified by a user will be stored in a record corresponding to the defined event.

In most embodiments of a define event type GUI 725, the GUI will further comprise an okay command button 820 and a cancel command button 825. These command buttons, when actuated by user, will cause triggers to be forwarded to the project management executive 700 causing the project management executive to update the event definitions table 40 with information entered in the define event type GUI 725 by the user (okay command) or to discard any information that the user may have entered into the defining event type GUI 725 (cancel command). Some embodiments of the present invention may further comprise a define event type GUI 725 comprising a “new” command button 830. The “new” command button 130 may cause a trigger to be dispatched by the GUI manager 725 to the project management executive 700 causing the project management executive 700 to create a new record in the event definitions table 40. This new record may then be used to store information about a new event that a user may specify.

In yet another alternative embodiment of the present invention, the define event type GUI 725 may further comprise a macro definition-data entry control 792. The macro definition data entry control 792 may comprise one or more macro definition lines 793. A macro definition line 793 may comprise a macro number field 797 and an executable reference field 806. Optionally, a macro definition line 793 may further comprise a logical name field 801.

According to this illustrative embodiment of the present invention, a user may specify one or more executable files that may be spawned when a particular event is acknowledged. Where more than one executable files (i.e. macro) must be spawned in response to the particular event, a distinguishing value may be stored in the macro number field 797. In some embodiments, the macro number field 797 may be automatically set by the GUI manager 725. The user may enter a logical name into the logical name field 801 and may then provide a reference, such as a directory path and a filename, for an executable file. According to one variation of this invention, a user may also provide a command line that may be used to launch a stand-alone application.

Once a user enters macro information using the macro definition data and control 792, the GUI manager 715 may pass this information to the project management executive 700. The project management executive 700 may then stored the information in an event macro table 72 that may be further used by a software system that implements the methods of the present invention. The event macro table 72 may comprise an event type field 77 and a reference to executable field 92. The project management executive 700 may cause a database engine 705 create a new record in the event macro table 72 when a user specifies a new macro that ought to be spawned in response to a particular event. The project management executive 700 may cause the identifier of the particular event type to be stored in the event type field 77 and a reference to an executable file received from a user in the reference to executable field 92 in the record. Where more than one macro is to be spawned or sponsor a particular event, the project management executive 700 may use a macro number field 82 to distinguish among records pertaining to the same event type. Optionally, the project management executive 700 may accept a logical name for the macro to store this in a macro name field 87 that may optionally comprise the event macro table 72.

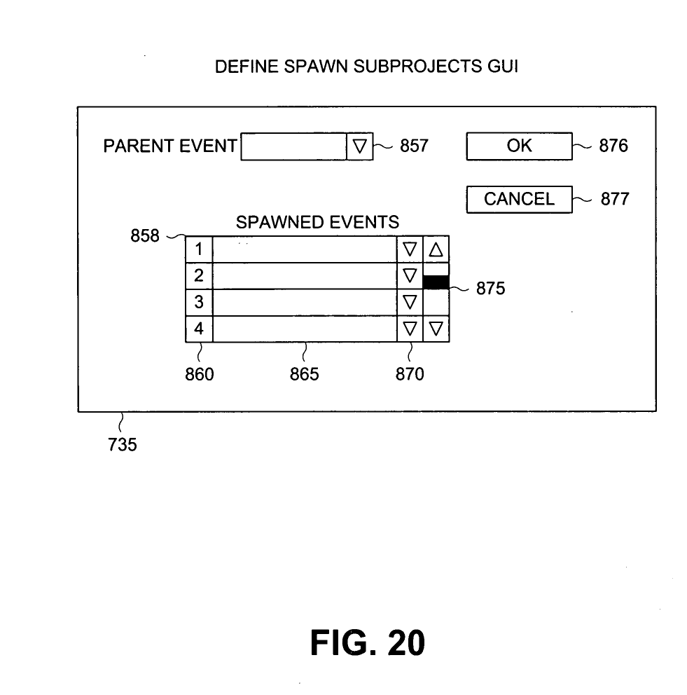

FIGS. 19 and 20 are pictorial representations of illustrative embodiments of a define spawned events GUI and a define spawned subprojects GUI that may be used by a user to specify what events/subprojects may be spawned in response to a particular event. According to one illustrative embodiment of the present invention, the GUI manager 715 may create a define spawned events GUI 730 and present this to a user. The define spawned events GUI 730 may comprise a parent event data entry control 835. The define spawned events GUI 730 may further comprise a spawned events list data entry control 837.

According to this illustrative embodiment, a user may select a predefined event type using the parent event data entry control 835. In a typical embodiment, the parent event data entry control 835 comprises a drop-down list that is populated with event types that may be defined in the event definitions table 40. Hence, a user selection may be constrained to event types actually defined by records stored in the event definitions table 40.

Once a user has selected a parent event using the parent event data entry control 835, the user may specify events that may be spawned in response to the selected parent event. This may be done by using the spawned events list data entry control 837. The spawned events list data entry control 837 may itself comprise one or more spawned events data entry controls 845. These may be drop-down lists that may be used to constrain user entry of spawned events to events reflected in the event definitions table 40. The spawned events list data entry control 837 may further comprise a scroll bar 855 to allow a user to view more spawned events data entry controls 845 than a particular physical display may accommodate.

According to this embodiment of the present invention, the define spawned events GUI 730 may further comprise an okay command button 856 and a cancel command button 857. The GUI manager 715 may issue triggers to the project management executive 700 when a user actuates either of these command buttons. In the case of the okay command button 856, the project management executive 700 may receive information entered into the various controls comprising the define spawned events GUI 730 and may use this information to create records in a spawned events table 130 that may further be used by the project management executive 700 to record spawning definitions for events. Hence, for every spawned event for a parent event specified by a user, a new record may be created by the database engine 705 in the spawned events table 130. The identifier of the parent event will typically be stored in the event type field 135 of a new record. The identifier of the event to be spawned will likewise be stored in the event type to spawn field 145. Where more than one event is to be spawned in response to a particular parent event, the project management executive 700 may use the spawn number field 140 to distinguish between records pertaining to report together type of parent event. When a user actuates the cancel button 857, the project management executive 700 will respond to a trigger issued by the GUI manager 715 by ignoring all data entry that may otherwise be received from a user.

According to one alternative embodiment of the present invention, a user may also specify what subprojects may be spawned in response to a particular parent event. The GUI manager 735 may generate a define spawned subprojects GUI 735 comprising a parent event data entry control 857 and a spawned subprojects list data entry control 858. The spawned subprojects list data entry control may itself be comprised of one or more spawned subprojects data entry controls 865. Using the define spawned subprojects GUI 735 that may be generated by the GUI manager 715, a user may select one or more subprojects that may be spawned in response to a particularly selected parent event. The spawned subprojects list data entry control 858 may further comprise a scroll bar 875 so that a user may view more spawned subprojects than a particular physical display device may accommodate.

In a manner analogous to that described above for the definition of spawned events, the project management executive 700 may respond to a trigger issued by the GUI manager 715 when a user actuates an okay command button 876 that may further comprise the define spawned subprojects GUI 735. The project management executive 700 may respond by receiving a parent event identifier and one or more identifiers for subprojects that should be spawned in response to the parent event. This information can then be used by the project management executive 700 to cause the database engine 705 to create new records in a spawned subprojects table 160 that may be further used by the software of the present invention to record what subprojects should be spawned response to particular event.

Accordingly, the spawned subprojects table 160, which may comprise an event type field 165, a spawned number field 170 and a subproject to spawn field 175, may be augmented with new records corresponding to entries made by a user in the define spawned subprojects GUI 735. In one embodiment, the selected parent event will be stored in the event type field 165 and a subproject identifier corresponding to a subproject to be spawned would be stored in the subproject to spawn field 175. Where more than one subprojects is to be spawned in response to particular parent event, the project management executive 700 may use the spawn number field 170 to distinguish among records in the spawned subprojects table 160 having identical parent event types specified in the event type field 165.

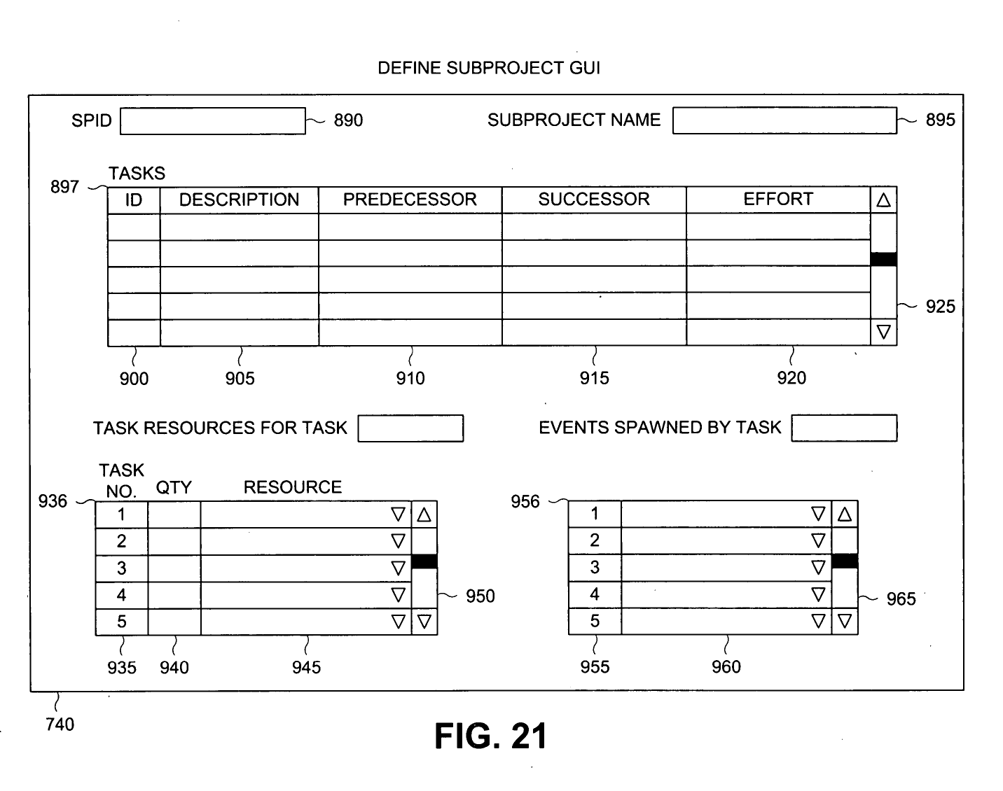

FIG. 21 is a pictorial representation of one illustrative embodiment of a define subproject GUI that may be used by a user to specify the structure of a subproject that may be spawned in response to an event according to the teachings of the present invention. According to this illustrative embodiment, a define subproject GUI 740 may be comprised of the subproject identifier data entry control 890 and a subproject named data entry control 895. A user may provide a subproject identifier and a subproject name using these two data entry controls. This information may then be conveyed to the project management executive 700. The project management executive 700 may then cause the database engine 705 to create a new record in a subproject details table 192.

The subproject details table 192 may comprise a subproject identifier field 197 and a subproject name field 202.

The define subproject GUI, as embodied in this illustrative example, may further comprise a task list data entry control 897. The task list data entry control 897 may further be comprised of one or more task description lines comprising fields for a task identifier 900 and a task description 905. A task description line may further comprise a predecessor field 910 and a successor field 915. The task description line may further be comprised of an effort field 920. Where any given physical display device cannot simultaneously display all of the tasks associated with a particular subproject, the task list data entry control 897 may further comprise a scroll bar 925 that may be used by a user to scroll through task description lines comprising the task list data entry control 897.

A user may enter a task identifier and description for a new task comprising a subproject in a description line comprising the task list data entry control 897 in corresponding fields (900, 905). This information may then be conveyed by the GUI manager 715 to the project management executive 700. The project management executive 700 may then cause the database engine 705 to create new records in a subproject definition table 190. The subproject definition table may comprise a subproject identifier field 195, a task identifier field 200 and a task description field 205. For each record, the subproject identifier field 195, task identifier field 200 and the task description field 205 may be used to store information entered by the user using the define subproject GUI 740.

Where a user wishes to specify a predecessor or successor task for a particular task, the identifier of the predecessor or successor task may be stored in a predecessor field 210 and/or successor field 215 that may further comprise the subproject definition table 190. Likewise, where a user wishes to specify an effort value for a particular task using the effort field 920 of a particular task description line comprising the task list data entry control 897, that value may be stored in the subproject definition table 190 in an effort field 220 comprising the table. Typically, a new record is created in the subproject definition table 190 for each new task specified by the user corresponding to a particular subproject.

According to one embodiment of a define subproject GUI 740, a user may specify resources that may be required to support a particular task. A user may also specify, according to yet another alternative embodiment of this invention, events that may be spawned in response to a particular task. Lexically, the user may select a particular task by highlighting the task's description line in the task list data entry control 897. When so highlighted, other controls comprising the define subproject GUI 740 may be used to enter resources and events related to the task.

The task resource list data entry control 936 may be used to specify one or more resources that are necessary to accomplish the task highlighted in the task list data entry control 897. Likewise, the events spawned by the highlighted task may be specified by the events to spawn lists data entry control 956. Each of these controls may further comprise a scroll bar (950, 965) that may be used to scroll through resources or events to be spawned where there are more entries in these controls than a particular physical display device may simultaneously present.

The task resource list data entry control 936 may further comprise one or more resource lines that each may comprise a resource number field 935, a resource quantity field 940 and a resource type field 945. Information for particular task specified in the task resource list data entry control 936 may be propagated to the project management executive 700. The project management executive 700 may then cause the database engine 705 to store this information in a subproject resource guide table 230. The subproject resource guide table 230 may comprise a subprojects identifier field 235, a task identifier field 240, a resource number field 245, a resource type field 250 and a quantity required field 255. Where more than one resource is required to support a particular task, the project management executive 700 may use the resource number field 245 to distinguish among records pertaining to a particular task comprising a particular subproject. Project management executive 700 will typically cause a new record to be created for each resource for a particular task and will store the identifier for the particular subproject in the subproject identifier field 235 and will store the identifier for the particular task in the task identifier field 240. The type of resource to be used may then be stored in the resource type field 250 along with the quantity of that resource which may be stored in the quantity required field 255. According to one alternative embodiment of the present invention, the resource field 945 may be a drop-down list that may be used to constrain the user's entry of a resource type to a pre-established list of resource types.

When a user highlights a particular task in the task list data entry control 897, the user may then specify what events may be spawned in response to that particular task. Using the events to be spawned data entry control 956, which may comprise one or more event lines each comprised of an event number field 955 and an event type field 960, the user may specify one or more events that must be spawned when the highlighted task is acknowledged. For the purposes of this disclosure, acknowledgment may be viewed as the completion or accomplishment of a particular task. But, alternative embodiments of this invention will allow an event to be spawned when a task is initiated or at any particular time during its execution.

The project management executive 700 may receive entries from the user and store definitions of what events ought to be spawned in response to a particular task in a task spawns events table 270. The task spawns events table 270 may comprise a subproject identifier field 275, a task identifier field 280, an event number field 287 and an event to spawn field 285. In one illustrative embodiment of the present invention, the project management executive 700 may use the event number field 287 to distinguish among records pertaining to a particular subproject/task. The subproject identifier and the task identifier may then be stored in the subproject identifier field 275 and the task identifier field 280 for a new record in the task spawns events table 270. The identifier of an event to be spawned may then be stored in the event to spawn field 285. According to one embodiment of the present invention, the event type field 960 comprising a line in the events to be spawned lists data entry control 956 may comprise a drop-down list that may be used to constrain a user's selections to events specified in the event definition stable 40. This information will typically be received by the project management executive 700 from the GUI manager 715. The project management executive may then command the database engine to update tables in the database accordingly.

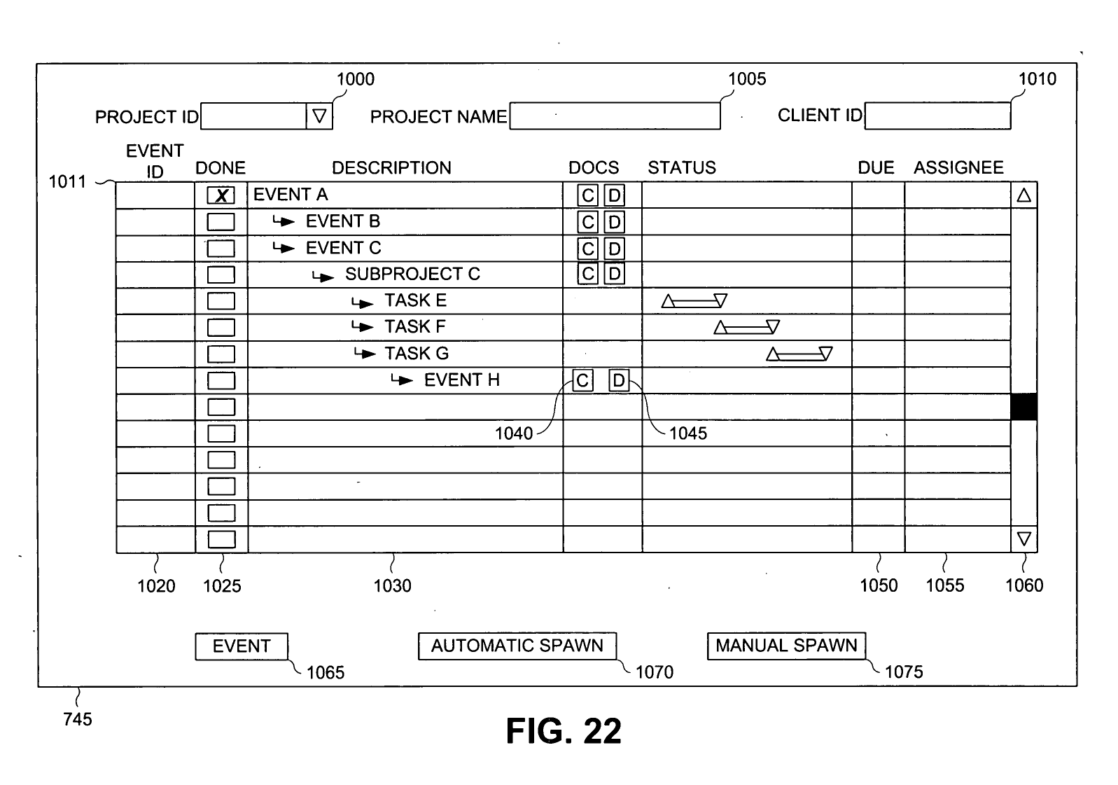

FIG. 22 is a pictorial representation of one example embodiment of a project tracking GUI that may be used to track projects according to the teachings of the present invention. According to one illustrative embodiment of the present invention, the GUI manager 715 may create the project tracking GUI 745 comprising a project identifier data entry control 1000 and a project name data entry control 1005.

According to one embodiment of a software program for tracking projects through events, the user may select a project to track using the project identifier data entry control 1000. Typically, this control may comprise a drop-down list that may be populated with project identifiers that may be stored in a project table 200. Once selected, the GUI manager 715 will send a signal to the project management executive 700 comprising the user's selection. In response, the project management executive 700 will consult the project table 300 using the selection as an index and retrieve the name of the project from the project name field 310 of that table. The project management executive 700 will then convey the project name to the GUI manager 715. The GUI manager 715 may then present the name of the project using a project name data control 1005 that may further comprise the project tracking GUI 745.

As already discussed, the project table may be used to store information about projects that may be managed by a software program that implements the methods of the present invention. Hence, each project may be represented by a record stored in the project table 300 and typically will have a unique project identifier stored in the project identifier field 305. When the user selects a particular project using the project identifier data entry control 1000, the GUI manager 715 will send the identifier value of the selected project to the project management executive 700. In response, the project management executive may consult various tables, including but not limited to the project table 300, an event table 330, and a spawned event or subproject table 400. The project management executive 700 may further consult a spawned subproject table 430 and an events spawned by task table 500.

In most embodiments of this invention, the events table 330 may comprise a project identifier field 335, an event number field 340 and an event type field 345. The event table 330 may further comprise an event date field 350. The event table 330 may further comprise an event due field 355. And yet other embodiments of this invention, the event table 330 may further comprise a pertains to field 365 and a disposition field 370. In yet another alternative embodiment of this invention, the event table may comprise an on create field 375 and/or an on done field 380. In another alternative embodiment of this invention, the event table 330 may further comprise a done field 385.

In most embodiments of this invention, the spawned event or subproject table 400 may comprise a project identifier field 405, an event number field 410, a spawned the event number field 415 and an event/subproject distinguishment field 420. The spawned subproject table 430 may comprise a project identifier field 435, a spawned the event number field 440, a subproject number field 445, a subproject identifier 450 and a task identifier field 455. The spawned subproject table 430 may further comprise an actual start and an actual completion fields (460, 480). The spawned subproject table 430 may further comprise an estimated start and an estimated completion field (470, 490).

According to one embodiment of this invention that illustrates how a project may be tracked using the project tracking GUI 745, the project management executive 700 will cause the database engine 705 to retrieve one or more records from the events table 330 wherein the project identifier field 335 is equal to the project identifier received from the GUI manager 715 as a result of a selection made by a user using the project identifier data entry control 1000 comprising the project tracking GUI 745.

In yet one additional alternative embodiment of the present invention, the software that implements the methods of the present invention may then examining all of the records retrieved from the event table and identify the first event that is not descendant from another event. According to this embodiment, the project tracking GUI 745 may comprise an event list data entry control 1011. The event list data entry control 1011 may itself be comprised of one or more event description lines 1015. An event description line may comprise an event identifier field 1020, a done field 1025 and an event description field 1030.

For the first identified event, the project management executive may cause the GUI manager 715 to prepare and present an event description line 1015 reflecting the event identifier, the “done” status of the event and an event description. Typically, the project management executive 700 will retrieve this information from the event table 330, specifically from a record reflecting the event and from the event number field 340 and the event done field 385. The project management executive 700 will also retrieve the type of event from the event type field 345 and use this value as an index into the event definition table 40. By so indexing the event definition table 40, the project management executive 700 may retrieve a description for the event from the description field 50 comprising the event definition stable 40. This description may then be passed to the GUI manager 715 so that it may be incorporated into the description field for the event description line 1015 corresponding to the event.

Once the information for the event is presented in a first event line 1015, the project management executive 700 may cause the database engine 705 to retrieve records from the spawned events or subproject table 400 having a project identifier field 405 equal to the project identifier received from the GUI manager 715 in response to a project selection made by a user and an event number field 410 equal to the event identifier of the event presented in the first event line 1015. This process allows the project management executive 700 to find descendant events for any particular parent event and may identify the descendant event by an identifier stored in the spawned event identifier field 415 of the spawned events or subprojects table 400.

Where a descendant event is discovered, the project management executive 700 may cause the GUI manager 715 to prepare and present an additional event description line for the descendant event. In this case, the event identifier field 1020 and the “done” status field 1025 are generated in a manner analogous to that of a descriptor line prepared for the parent event. Typically, a hierarchical indicator that may indicate the descendant relationship between a first event and any second event and may be presented in the description field 1030 in the event description line 1015 for the descendant event. This same process is used to present descendant subprojects that may be discovered when the project management executive 700 consults the spawned event or subproject table 400. The project management executive 700 may use the event/subproject distinguishment field 420 of a particular record in the spawned event or subproject table 400 to determine if a subproject was actually spawned by a particular parent event.

In the event that a subproject was spawned by a particular parent event, the project management executive 700 may consult a spawned subproject table 430 in order to discover what tasks comprise the spawned subproject. To affect this, the project management executive 700 may cause the database engine 705 to retrieve records from the spawned subproject table 430 wherein the project identifier field 435 is equal to the project identifier received from the GUI manager 715 in response to a user's selection of a project using the project identifier data entry control 1000 comprising the project tracking GUI 745 and wherein the spawned event number field 440 is equal to the identifier of the event the spawned subproject. The spawned subproject identifier may also be used to select records using the subproject identifier field 450. A task may then be identified by retrieving the value of the identifier stored in the task identifier field 455.

Once a task is identified, the project management executive 700 may cause the GUI manager 715 to prepare and present an event line reflecting information associated with the task. The project management executive 700 may retrieve information such as an actual start or actual completion date for the task from the appropriate fields (460, 480) in the record associated with a task comprising a spawned subproject. Estimated start or estimated completion dates for the task may also be retrieved from the record for the appropriate fields (470, 490). The completion status of a task may also be retrieved from a done field 495 comprising the record. This information may then be presented by the GUI manager 715 in the event line prepared for a task comprising a spawned subproject.

In some cases, a task may actually spawn an event. In order to discover if a task has descendant events, the project management executive 700 may cause the database engine 705 to retrieve records from the events spawned by task table 500. Retrieval of records may be based on selection of records wherein the project identifier field 505 is equal to the project selected by a user and retrieved from the project identifier data entry control 1000 comprising the project tracking GUI 745. The selection criteria may further comprise matching of the spawning event number (with the spawning event field 510) that spawned a particular subproject (with the subproject identifier field 520) and the identifier of the task that is spawning event (task identifier field 525). The resulting record may then be examined and an identifier for the spawned event may be retrieved from the spawned event identifier field 530. The project management executive 700 may then cause the GUI manager 715 to create and present a new event line in the event list data entry control 1011 in the usual manner as taught above.

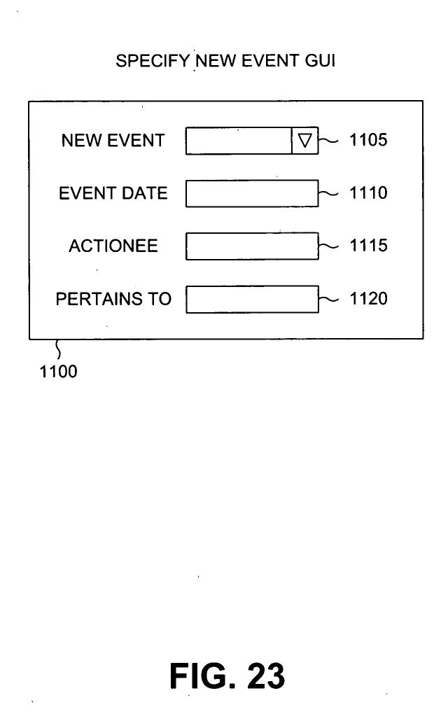

FIG. 23 is a pictorial representation of a new event selection GUI that may be used by a user to acknowledge a new event. According to one alternative embodiment of the present invention, the project tracking GUI 745 may further comprise an event command button 1065. When a user actuates the event command button 1065, the GUI manager 745 sends a signal to the project management executive 700. In response, the project management executive may create a new event record in the events table 330 for a particular project, i.e. the project selected by the user using the project identifier data into control 1000 comprising the project tracking GUI 745.

To do so, the project management executive 700 may cause the database engine 705 to create a new record in the event table 330 and may cause the project identifier field 335 of the new record to be set the identifier of the user selected project. The event number field 340 may be set to the next sequential value for a particular project. The GUI manager 745 may then present the user with a new event selection GUI 1100 comprising a data entry control 1105 for selection of an event type. According to one embodiment of the present invention, the new event selection GUI data entry control comprises a drop-down list that may be used to constrain a user's selection to the types of events specified in the event definitions table 40. The value selected by the user may then be stored in the type field 345 of the new event record.

The new event selection GUI may further comprise an event date data entry control 1110 that may be used to receive from the user an event date that may then be stored in the event date field 350 of the new record. The new event selection GUI may further comprise an actionee data entry control 1115 that may be used to receive from the user an actionee. The actionee value may then be stored in the actionee field 360 comprising the record. Likewise, the event selection GUI may also further comprise a pertains to data entry control 1120 that may be used to receive from the user a pertains to specification that may then be stored in the pertains to field 365 of the new record. The values stored in the actionee and pertains to fields of the new record may be used by ancillary processes of the present invention for notification purposes; i.e. notifying an actionee that an event requires their attention or other parties that may be interested in the event.

According to one alternative embodiment of the present invention, the project tracking GUI 745 may further comprise an auto spawn command button 1070. When a user actuates the auto spawn command button 1070, the GUI manager 715 may issue a signal to the project management executive 700. The GUI manager 715 may also allow the user to highlight (i.e. select) a particular event presented in the event list data entry control 1011. This selection may also be forwarded to the project management executive 700. In response to this signal and associated event selection information, the project management executive 700 may create new events in the events table 330. The project management executive 700 will create these events if it discovers that the selected event has associated with it either events or subprojects that must be spawned when the event is acknowledged. This information may be discovered by using the database engine 705 to consult the spawn events table 130 and the spawn subprojects table 116. Typically, records in these tables will be selected if their event type field (135,165) is equal to the event identifier of the event selected by the user in the event list data entry control 1011 comprising the project tracking GUI 745.

Creating the records implies that new records in the event table will have their project identifier field 335, event type field 345 and event date field 350 set to values reflecting the current project, type of event spawned and the date upon which the event spawning occurred. A corresponding new record will be created in the spawned event or subproject table 400 setting the project identifier field 405, the event number field 410 and the spawned event field 415 to reflect the current project identifier, the identifier of the parent event and the identifier of the spawned (or descendant) event.

According to one alternative embodiment of this invention, subprojects may be spawned in a like manner. When the project management executive 700 discovers that a particular event requires an automatic spawning of a subproject, it may consult the subproject definitions table 190 in order to determine what tasks must be spawned for a particular subproject. This may be done by selecting records according to the subproject identifier field 195 and the task identifier field 200 comprising the subproject definitions table 190.

Once the task comprising a subproject that must respond is identified, the project management executive 700 may cause the database engine 705 to create a new record in a spawned subprojects table 430. The spawned subprojects table 430 may comprise a project identifier field 435, a spawning event number field 440, a subproject number field 445, a subproject identifier field 450 and a task identifier field 455. The project management executive 700 may then cause the project identifier field 435 of the new record to be set to the current project as specified by a user selection receive from the GUI manager 715. The spawning event number field 440 for the new record may then be set to the identifier of the event from which the subproject is being spawned. The subproject identifier field 450 and a task identifier field 455 may then be set to reflect the appropriate task comprising the subproject that is being spawned.

The project management executive 700 may also cause the database manager 705 to create a new record in the spawned event or subproject table 400. This new record will be set to reflect the spawning of a subproject by setting the project identifier field 405, the event number field 410, the spawned event number field 415 to the value of the current project, parent event and the identifier of the spawned subproject. The event/subproject distinguishment field 420 may also be set to reflect that the spawned event number field 415 has been used to record a subproject identifier rather than an event identifier.

In some cases, the project management executive 700 may discover that an event must respond in response to the completion of a task comprising a subproject. This discovery may be made by consulting the task spawns event table 270. In response, the project management executive 700 may create the new record in the events table 330 for the event that must be spawned in response to the task. An appropriate addition of a record must be made to the events spawned by task table 500. This record is used to note the parent-descendant relationship between the task and the event spawned in response to the task.

Whenever a new event is acknowledged or spawned, the project management executive 700 may retrieve an auto due value events definitions table 40 auto due field 55. The project management executive 700 may further cause the database engine 705 to store a calculated event due value in the event due field 355 for the record corresponding to the acknowledged or spawned event. Typically, the calculated due value is generated by adding the auto due value retrieve from the event definitions table 40 to the date of the event as stored in the event table 330 event date field 350.

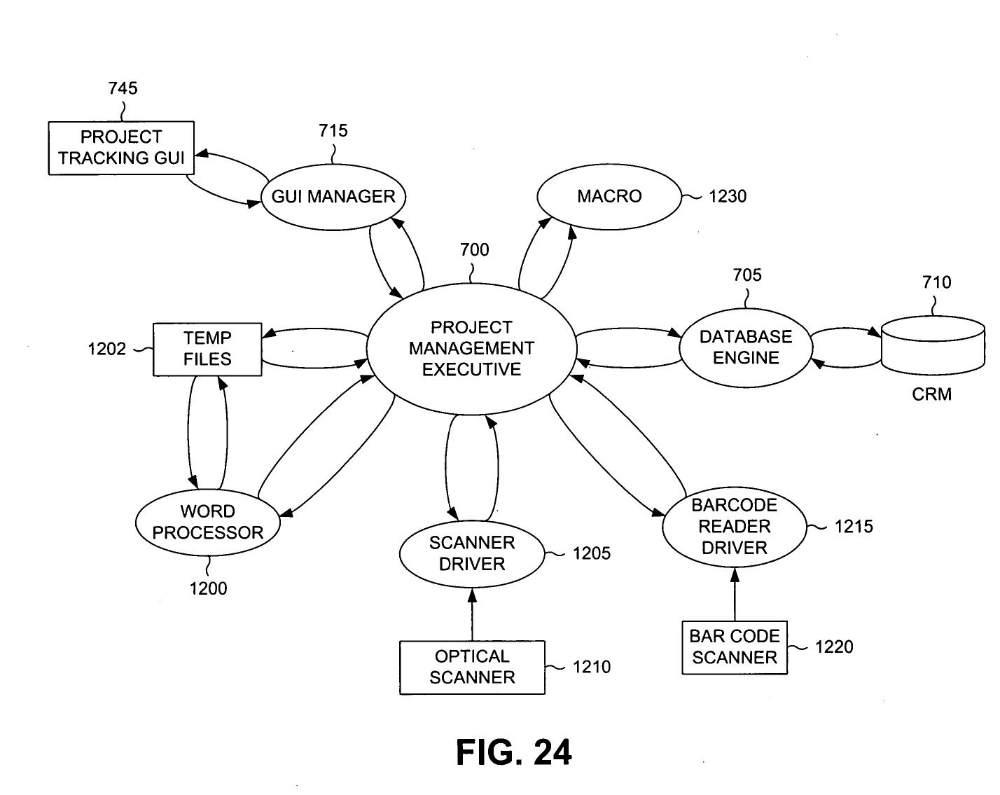

FIG. 24 is a data flow diagram that depicts some illustrative interactions between a project management executive and helper applications according to the teachings of the present invention. The project tracking GUI 745 may comprise event descriptor lines 1015 to may further comprise document command buttons. One such command buttons may be an on create command button 1040. Another command button may be an on done command button 1045. According to one embodiment of the present invention, the GUI manager 715 may issue a signal to the project management executive 700 when a user actuates either of these command buttons. In response, the project management executive 700 may cause a helper application to be executed. According to one variation of the present invention, GUI manager 715 may also provide event selection information to the project management executive 700 when a user actuates either of these command buttons.

Upon receiving an event selection and a signal corresponding to either of these command buttons, the project management executive may consult the events definitions table 40 in order to determine what type of media action must be taken in response to the signal receive from the GUI manager 715. Using the event selection as an index, the project management executive 700 will retrieve the value stored in the form on create field 65 for the record corresponding to the event selection receive from the GUI manager 715 in response to an on create command button signal. In response to an on done command button signal, the project management executive 700 will retrieve the value stored in the form on done field 75. Optionally, the project management executive may retrieve document templates associated with the form on create or the form on done (70, 80).

Based on either the form on create or the form on done value retrieve from the event definitions table 40, the project management executive 700 will launch a helper application. Some examples of helper applications that may be launch by the project management executive 700 may include the word processor 1200, a standard driver 1205 and a bar code reader driver 1215. This list is meant to illustrate the concept of the present invention and should not be construed as limiting the scope thereof.

The project management executive 700 may first prompt a user as to whether a new media file is to be created or if an existing media file is to be edited. In the case of a new media file creation, the project management executive 700 may launch a helper application and then retrieve the media file there from. The resulting file may be stored in the on create field 375 or the on done field 380 for the record corresponding to the event selected by the user using the project tracking GUI 745. When the resulting file is stored in the database managed by the database engine 705, the on create field 375 and/or the on done field 380 may constitute binary large object (BLOB) data type capable of storing arbitrary digital data. In an alternative embodiment of this invention, the on create field 375 and/or the on done field 380 may be used to store a reference to the resulting file; such as a directory path and filename. The resulting file created by the helper application may then be stored directly on a computer readable media 710 and maybe managed by a file system.

Some examples of the creation of a new media file may include the use of a scanner driver 1205 to acquire a digital image of a document using an optical scanner 1210. The present invention may also invoke a bar code reader driver 1215 so that a bar code can be scanned in the value of the bar code may then be stored in either the on create field 375 or the on done field 380 depending on what command button was actuated by the user. These are just some examples of the types of media file is that may be stored either upon the creation of an event or upon completion of the event (i.e. after execution of a responsive action).

In many situations, the software of the present invention may further retrieve a template for a particular media action that may need to be accomplished based upon either an on done for an on create command button event perceived by the GUI manager 715. In order to retrieve a template, the project management executive 700 may consult the event definitions table 40 for the particular event highlighted by a user. Retrieving either a reference for the template itself from the template field associated with the form on create 70 or the template field associated with the form on done 80, the project management executive 700 may create a temporary file 1202 reflecting the template.

A helper application, such as a word processor 1200, may then read the template from the temporary file and use the template to govern the structure of a media file generated in response to an on create and/or an on done event. The helper application may likewise store the resulting media file in a temporary file. The project management executive 700 may then store the contents into a permanent file on the computer readable media 700 or directly in the record that defines the event in the event table 330. Where the project management executive stores the generated media file directly in the database, the on create field 375 and/or the on done field 380 may comprise BLOB data types that are capable of storing the binary data file. Alternatively, these fields may be used to store a reference to a file stored on the computer readable media 710 and managed directly by a disk file system. The reference may be a directory path and a filename.

When an existing media file either referenced by or stored in the on create field 375 or the on done field 385 of a particular event record must be modified, it may be first copied to a temporary file 1202. The helper application may then operate on the temporary file 1202 to affect any changes. The project management executive 700 may then copy the changed file from the temporary file 1202 back to its original location; either a file referenced by the on create field 375 or the on done field 385 or as a binary image stored in event record itself.

The present invention may also discover if a particular event, once acknowledged, requires us the execution of a macro. To discover this, the project management executive may consult the event of macro table 72. When an event is acknowledged, the project management executive may use the identifier value of the event as an index into the event of macro table 72. If the project management executive 700 discovers any record in the event macro table wherein the event type field 77 is equal to the identifier of a newly acknowledged event, it may then retrieve a reference to an executable file from the reference to executable field 92 from that record. The project management executive may then launch the macro 1230. Once the macro is finished executing, the project management executive 700 typically regains control and may notify the user or take other appropriate action such as marking an event completed, i.e. done. In some embodiments of this invention, the project management executive 700 may receive a command line from the reference to executable field 92. In this case, project management executive 700 may launch a stand-alone application using the command line. According to one embodiment of this invention, the stand-alone application may use the command line to determine if it must execute a high-level pseudo language program.

Alternative Embodiments

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents. Some, but by no means all of the possible alternatives are described herein.

I claim:

1. A method for managing a project comprising:
recognizing an event;
logging the event; and
spawning a task that is associated with the event.

2. The method of claim 1 further comprising assigning a resource to the task.

3. The method of claim 1 further comprising scheduling the task.

4. The method of claim 3 wherein scheduling a task comprises:
determining an automatic due period for a task associated with the event; and
establishing a due date for the associated task based on the occurrence of the event and the automatic due period.

5. The method of claim 1 further comprising:
determining what type of computer file needs to be associated with the event; and
associating a computer file of the determined type with the event.

6. The method of claim 5 wherein associating a computer file with the event comprises:
retrieving a template file;
retrieving information from a database according to the template file;
creating a file image according to the template and the information retrieved from the database; and
at least one of storing the file image in a database record wherein the record is discoverable according to the event and storing the file image in a computer file and also a reference to the computer file in a database record wherein the record is discoverable according to the event.

7. The method of claim 5 wherein associating a computer file with the event comprises:
acquiring a graphic image;
creating a file image according to the graphic image; and
at least one of storing the file image in a database record wherein the record is discoverable according to the event and storing the file image in a computer file and also a reference to the computer file in a database record wherein the record is discoverable according to the event.

8. The method of claim 1 further comprising executing a macro associated with the event.

9. The method of claim 1 wherein spawning a task comprises spawning a subproject comprised of a plurality of tasks.

10. The method of claim 1 further comprising:
enumerating a description of the event;
enumerating a task description when the spawned task consists of one task; and
enumerating a subproject description when the spawned task comprises of a plurality of tasks.

11. The method of claim 10 wherein enumerating a subproject description comprises representing each task in a subproject in a timeline format.

12. The method of claim 10 further comprising providing an indication when a computer file is associated with the event.

13. The method of claim 10 further comprising presenting to a user a computer file when such computer file is associated with the event.

14. A computer program for managing a project comprising a project management executive that is capable of:
recognizing an event;
logging the event; and
spawning a task that is associated with the event.

15. The computer program of claim 14 wherein the project management executive is further capable of assigning a resource to the task.

16. The computer program of claim 14 wherein the project management executive is further capable of scheduling the task.

17. The computer program of claim 16 wherein the project management executive schedules a task by:
determining an automatic due period for a task associated with the event; and
establishing a due date for the associated task based on the occurrence of the event and the automatic due period.

18. The computer program of claim 14 wherein the project management executive is further capable of:
determining what type of file needs to be associated with the event; and
associating a computer file of the determined type with the event.

19. The computer program of claim 14 wherein the project management executive associates a computer file with the event by:
retrieving a template file;
retrieving information from a database according to the template file;
creating a file image according to the template and the information retrieved from the database; and
at least one of storing the file image in a database record wherein the record is discoverable according to the event and storing the file image in a computer file and also a reference to the computer file in a database record wherein the record is discoverable according to the event.

20. The computer program of claim 14 wherein the project management executive associates a computer file with the event by:
acquiring a graphic image;
creating a file image according to the graphic image; and
at least one of storing the file image in a database record wherein the record is discoverable according to the event and storing the file image in a computer file and also a reference to the computer file in a database record wherein the record is discoverable according to the event.

21. The computer program of claim 14 wherein the project management executive is further capable of executing a macro associated with the event.

22. The computer program of claim 14 wherein the project management executive spawns a task by spawning a subproject comprises of a plurality of tasks.

23. The computer program of claim 14 further comprising a project management user interface that is capable of:
enumerating a description of the event;
enumerating a task description when the spawned task consists of one task; and
enumerating a subproject description when the spawned task consists of a plurality of tasks.

24. The computer program of claim 23 wherein the project management user interface enumerates a subproject by representing each task in a subproject in a timeline format.

25. The computer program of claim 23 wherein the project management user interface is further capable of presenting a file access control when a computer file is associated with the event.

26. The computer program of claim 25 wherein the project management executive is further capable of launching a helper application and also providing an image of the computer file to the helper application when a user actuates the file access control.
